(19) United States
(12) Patent Application Publication
(10) Pub. No.: US 2006/0199206 A1
(43) Pub. Date: Sep. 7, 2006

(54) Method for identifying skin care composition-resistant skin-binding peptides

(76) Inventors: Hong Wang, Kennett Square, PA (US); Ying Wu, Wallingford, PA (US); John P. O'Brien, Oxford, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/359,162

(22) Filed: Feb. 22, 2006

Related U.S. Application Data
(60) Provisional application No. 60/657,494, filed on Mar. 1, 2005.

(51) Int. Cl. C40B 40/10; C40B 40/08

(52) U.S. Cl. 435/6; 435/7.1

(57) ABSTRACT

A method for identifying skin care composition-resistant skin-binding peptides is described. The skin care composition-resistant skin-binding peptides bind strongly to skin from a skin care composition matrix and are stable therein. Peptide-based skin benefit agents, such as skin conditioners and skin colorants, based on the skin care composition-resistant skin binding peptides are described. The peptide-based skin conditioners and skin colorants consist of skin care composition-resistant skin-binding peptide coupled to a skin conditioning agent or a coloring agent, either directly or through an optional spacer. Skin care and skin coloring product compositions comprising these peptide-based skin conditioners and colorants are also described.

This patent application claims the benefit of U.S. Provisional Patent Application 60/657,494, filed Mar. 1, 2005.

### FIELD OF THE INVENTION

The invention relates to the field of personal care products. More specifically, the invention relates to a method for identifying skin care composition-resistant skin-binding peptides and the use thereof in peptide-based skin benefit agents, such as skin conditioner and skin colorants.

### BACKGROUND OF THE INVENTION

Skin conditioners and skin colorants are well-known and frequently used skin care products. The major problem with current skin conditioners and skin colorants is that they lack the required durability for long-lasting effects. In order to improve the durability of these compositions, peptide-based skin conditioners, skin colorants, and other benefit agents have been developed (Huang et al., copending and commonly owned U.S. Patent Application Publication No. 2005/0050656 and U.S. Patent Application Publication No. 2005/0226839). The peptide-based skin conditioners or colorants are prepared by coupling a specific peptide sequence that has a high binding affinity to skin with a conditioning or coloring agent, respectively. The peptide portion binds to the skin, thereby strongly attaching the conditioning or coloring agent. Peptides with a high binding affinity to skin have been identified using phage display screening techniques (Huang et al., supra; Estell et al. WO 0179479; Murray et al.,. U.S. Patent Application Publication No. 2002/0098524; Janssen et al., U.S. Patent Application Publication No. 2003/0152976; and Janssen et al., WO 04048399). The 0179479, 2002/0098524, 2003/0152976, and 04048399 applications describe contacting a peptide library with a skin sample in the presence of a dilute solution of bath gel (i.e., a 2% aqueous solution) and washing the resulting phage-peptide-skin complex with the bath gel solution during phage display screening; however, the concentration of bath gel used is too low to identify bath gel-resistant skin-binding peptides.

The skin-binding peptides have decreased binding affinity in the presence of a skin care composition matrix and therefore, do not bind strongly to skin from the composition matrix or are washed from skin by the application of a skin care product. Moreover, the skin-binding peptides are not stable for long periods of time in the skin care composition matrix, which causes their binding affinity to decrease with time in a skin care product composition.

Methods for identifying shampoo-resistant hair-binding peptides (Huang et al., copending and commonly owned U.S. Patent Application Publication No. 2005/0050656, and O'Brien et al., copending and commonly owned U.S. patent application Ser. No. 11/251,715), shampoo-resistant antibody fragments that bind to a cell surface protein of Malassezia furfur (Dolk et al., Appl. Environ. Microbiol. 71:442-450 (2005)), and hair conditioner-resistant hair-binding peptides (Wang et al., copending and commonly owned U.S. Patent Application No. 60/657,496) have been reported. However, methods for identifying skin care composition-resistant skin-binding peptides have not been described.

The problem to be solved, therefore, is to provide skin-binding peptides that are able to bind to skin from a skin care composition matrix and are stable therein.

Applicants have addressed the stated problem by discovering a method for identifying skin care composition-resistant skin-binding peptides. Skin care composition-resistant skin-binding peptide sequences identified by the method of the invention may be used to prepare peptide-based skin benefit agents, such as skin conditioners and skin colorants, having high binding affinity to skin in the presence of a skin care composition matrix and improved stability in a skin care composition.

### SUMMARY OF THE INVENTION

The invention relates to a method of identifying and isolating skin-binding peptides whose binding properties are not affected by the presence of skin care compositions. The skin care composition-resistant skin-binding peptides of the invention are screened from combinatorial peptide libraries and are provided in skin care compositions in diblock or triblock structures optionally comprising spacers and benefit agents such as, colorants and conditioners.

Accordingly, the invention provides a method for identifying a skin care composition-resistant skin-binding peptide comprising:
a) providing a combinatorial library of DNA associated peptides;
b) contacting the library of (a) with a skin sample wherein the skin complexes with the DNA associated peptide to form a reaction solution comprising DNA associated peptide-skin complexes;
c) isolating the DNA associated peptide-skin complexes of (b) from the reaction solution;
d) contacting the isolated DNA associated peptide-skin complexes of (c) with a skin care composition matrix to form a peptide-skin complex-composition mixture wherein the concentration of the skin care composition matrix is at least about 10% of full strength concentration;
e) isolating the DNA associated peptide-skin complexes of (d) from the peptide-skin complex-composition mixture;
f) amplifying the DNA encoding the peptide portion of the DNA associated peptide-skin complexes of (e); and
g) sequencing the amplified DNA of (f) encoding a skin care composition resistant skin-binding peptide wherein the skin care composition-resistant skin-binding peptide is identified.

Optionally the skin-binding peptides may be eluted from the skin with an eluting agent after step (e) and peptides identified by the method of the invention may be further refined by successive applications to the method.

In another embodiment the invention provides a skin care composition-resistant skin-binding peptide identified by a process comprising the steps of:
a) providing a combinatorial library of DNA associated peptides;
b) contacting the library of (a) with a skin sample wherein the skin complexes with the DNA associated peptide to form a reaction solution comprising DNA associated peptide-skin complexes;
c) isolating the DNA associated peptide-skin complexes of (b) from the reaction solution;
d) contacting the isolated DNA associated peptide-skin complexes of (c) with a skin care composition matrix to form a peptide-skin complex-composition mixture wherein the concentration of the skin care composition matrix is at least about 10% of full strength concentration;
e) isolating the DNA associated peptide-skin complexes of (d) from the peptide-skin complex-composition mixture;
f) amplifying the DNA encoding the peptide portion of the DNA associated peptide-skin complexes of (e); and
g) sequencing the amplified DNA of (f) encoding a skin care composition resistant skin-binding peptide wherein the skin care composition-resistant skin-binding peptide is identified.

Additionally, the invention provides a diblock; peptide-based skin benefit agent having the general structure (SCPₘ)ₙ−BA, wherein;

a) SCP is a skin care composition-resistant skin-binding peptide;

b) BA is a benefit agent;

c) m ranges from 1 to about 100; and

d) n ranges from 1 to about 50,000.

Similarly the invention provides a triblock, peptide-based skin benefit agent having the general structure [(SCPₓ−S)ₘ]ₙ−BA, wherein;

a) SCP is a skin care composition-resistant skin-binding peptide;

b) BA is a benefit agent;

c) S is a spacer;

d) x ranges from 1 to about 10;

e) m ranges from 1 to about 100; and

f) n ranges from 1 to about 50,000.

In another embodiment the invention provides a skin care product composition comprising an effective amount of the peptide-based skin conditioner of the invention. Similarly the invention provides a skin coloring product composition comprising an effective amount of the peptide-based skin colorant of the invention. Additionally, the invention provides a skin cleansing product composition comprising an effective amount of the peptide-based skin conditioner of the invention.

In an alternative embodiment the invention provides a method for forming a protective layer of a peptide-based conditioner on skin comprising applying the composition of the invention to the skin and allowing the formation of said protective layer. Similarly the invention provides a method for coloring skin comprising applying the composition of the invention to the skin for a period of time sufficient to cause coloration of the skin.

In another embodiment the invention provides a method for coloring skin comprising the steps of:
a) providing a skin coloring composition comprising a skin colorant selected from the group consisting of:
   i) (SCPₘ)ₙ−C; and
   ii) [(SCPₓ−S)ₘ]ₙ−C
      wherein:
      1) SCP is a skin care composition-resistant skin-binding peptide;
      2) C is a coloring agent;
      3) n ranges from 1 to about 50,000;
      4) S is a spacer;
      5) m ranges from 1 to about 100; and
      6) x ranges from 1 to about 10;
      and wherein the skin care composition-resistant skin-binding peptide is selected by a method comprising the steps of:
         A) providing a combinatorial library of DNA associated peptides;
         B) contacting the library of (A) with a skin sample wherein the skin complexes with the DNA associated peptide to form a reaction solution comprising DNA associated peptide-skin complexes;
         C) isolating the DNA associated peptide-skin complexes of (B) from the reaction solution;
         D) contacting the isolated DNA associated peptide-skin complexes of (C) with a skin care composition matrix to form a peptide-skin complex-composition mixture wherein the concentration of the skin care composition matrix is at least about 10% of full strength concentration;
         E) isolating the DNA associated peptide-skin complexes of (D) from the peptide-skin complex-composition mixture;
         F) amplifying the DNA encoding the peptide portion of the DNA associated peptide-skin complexes of (E); and
         G) sequencing the amplified DNA of (F) encoding a skin care composition-resistant skin-binding peptide wherein the skin care composition-resistant skin-binding peptide is identified; and
b) applying the skin coloring composition of (a) to skin for a time sufficient for the skin colorant to bind to skin.

In an additional embodiment the invention provides a method for forming a protective layer of a peptide-based conditioner on skin comprising the steps of:
a) providing a skin care composition comprising a skin conditioner selected from the group consisting of:
   i) (SCPₘ)ₙ−SCA; and
   ii) [(SCPₓ−S)ₘ]ₙ−SCA
      wherein:
      1) SCP is a skin care composition-resistant skin-binding peptide;
      2) SCA is a skin conditioning agent;
      3) n ranges from 1 to about 50,000;
      4) S is a spacer;
      5) m ranges from 1 to about 100; and
      6) x ranges from 1 to about 10;
      and wherein the skin care composition-resistant skin-binding peptide is selected by a method comprising the steps of:
         A) providing a combinatorial library of DNA associated peptides;
         B) contacting the library of (A) with a skin sample wherein the skin complexes with the DNA associated peptide to form a reaction solution comprising DNA associated peptide-skin complexes;
         C) isolating the DNA associated peptide-skin complexes of (B) from the reaction solution;
         D) contacting the isolated DNA associated peptide-skin complexes of (C) with a skin care composition matrix to form a peptide-skin complex-composition mixture wherein the concentration of the skin care composition matrix is at least about 10% of full strength concentration;
         E) isolating the DNA associated peptide-skin complexes of (D) from the peptide-skin complex-composition mixture;
         F) amplifying the DNA encoding the peptide portion of the DNA associated peptide-skin complexes of (E); and
         G) sequencing the amplified DNA of (F) encoding a skin care composition-resistant skin-binding peptide wherein the skin care composition-resistant skin-binding peptide is identified; and
b) applying the skin care composition of (a) to skin and allowing the formation of said protective layer.

### BRIEF DESCRIPTION OF THE SEQUENCE DESCRIPTIONS

The invention can be more fully understood from the following detailed description, and the accompanying sequence descriptions, which form a part of this application.

The following sequences conform with 37 C.F.R. 1.821-1.825 (“Requirements for Patent Applications Containing Nucleotide Sequences and/or Amino Acid Sequence Disclosures—the Sequence Rules”) and consistent with World Intellectual Property Organization (WIPO) Standard ST.25 (1998) and the sequence listing requirements of the EPO and PCT (Rules 5.2 and 49.5(a-bis), and Section 208 and Annex C of the Administrative Instructions). The symbols and format used for nucleotide and amino acid sequence data comply with the rules set forth in 37 C.F.R. §1.822.

SEQ ID NO: 1 is the amino acid sequence of the Caspase 3 cleavage site.

SEQ ID NO:2 is the nucleotide sequence of the oligonucleotide primer for sequencing phage DNA.

SEQ ID NO:3 is the amino acid sequence of a control hair-binding peptide, as described in Examples 4 and 15.

SEQ ID NO:4 is the amino acid sequence of a fluorescently labeled hair binding peptide, as described in Example 4.

SEQ ID NOs:5-7 are the amino acid sequences of peptide spacers.

SEQ ID NOs:8-25 are the amino acid sequences of body wash-resistant skin-binding peptides.

SEQ ID NO:26 is the amino acid sequence of a hair-binding peptide used as a control in Example 15.

SEQ ID NO:27 is the amino acid sequence of a body wash-resistant skin-binding peptide (SEQ ID NO:20) having a cysteine residue added to the C-terminal end.

### DETAILED DESCRIPTION OF THE INVENTION

The invention provides a method for identifying skin-binding peptides that specifically bind to human skin with high affinity in the presence of a skin care composition matrix. These skin-binding peptides may be used to prepare peptide-based skin benefit agents, such as skin conditioners and skin colorants, having high binding affinity to skin in the presence of a skin care composition matrix and improved stability in a skin care composition.

The following definitions are used herein and should be referred to for interpretation of the claims and the specification.

“SCP” means skin care composition-resistant skin-binding peptide.

“BA” means skin benefit agent.

“SCA” means skin conditioning agent.

“C” means coloring agent.

“S” means spacer.

The term “peptide” refers to two or more amino acids joined to each other by peptide bonds or modified peptide bonds.

The term “skin” as used herein refers to human skin, or substitutes for human skin, such as pig skin, Vitro-Skin® and EpiDerm™.

The phrase “skin care composition-resistant skin-binding peptide” refers to a peptide that binds strongly to skin from a skin care composition matrix and is stable therein.

The phrase “skin care composition matrix” refers to a medium comprising a skin care product, such as skin conditioners, skin cleansers, make-up, anti-wrinkle products and skin colorants, either undiluted or in diluted form, or a mixture comprising at least one component of a skin care product, in addition, at least two components of a skin care product. Components of skin care products include, but are not limited to, oils, waxes, gums, so-called pasty fatty substances, skin conditioning agents, skin colorants, antioxidants, preserving agents, fillers, surfactants, UVA and/or UVB sunscreens, fragrances, thickeners, wetting agents and anionic, nonionic or amphoteric polymers, and dyes or pigments.

The phrase “full strength concentration” refers to the concentration of components as they occur in a skin care product.

The term “benefit agent’ is a general term referring to a compound or substance that may be coupled with a skin care composition-resistant skin-binding peptide for application to skin to provide a cosmetic or dermatological effect. Benefit agents typically include conditioners, colorants, fragrances, sunscreens, and the like along with other substances commonly used in the personal care industry.

The terms “coupling” and “coupled” as used herein refer to any chemical association and includes both covalent and non-covalent interactions.

The term “peptide-skin complex” means structure comprising a peptide bound to skin via a binding site on the peptide.

The term “DNA associated peptide-skin complex” refers to a complex between skin and a peptide where the peptide has associated with it an identifying nucleic acid component. Typically, the DNA associated peptide is produced as a result of a display system such as phage display. In this system, peptides are displayed on the surface of the phage while the DNA encoding the peptides is contained within the attached glycoprotein coat of the phage. The association of the coding DNA within the phage may be used to facilitate the amplification of the coding region for the identification of the peptide.

The term “non-target” refers to a substrate for which peptides with a binding affinity thereto are not desired. For the selection of skin care composition-resistant skin-binding peptides, non-targets, include, but are not limited to, hair and plastic.

The term “amino acid” refers to the basic chemical structural unit of a protein or polypeptide. The following abbreviations are used herein to identify specific amino acids:

| | Three-Letter | One-Letter |
|---|---|---|
| Amino Acid | Abbreviation | Abbreviation |
| Alanine | Ala | A |
| Arginine | Arg | R |
| Asparagine | Asn | N |
| Aspartic acid | Asp | D |
| Cysteine | Cys | C |
| Glutamine | Gln | Q |
| Glutamic acid | Glu | E |
| Glycine | Gly | G |
| Histidine | His | H |
| Isoleucine | Ile | I |
| Leucine | Leu | L |
| Lysine | Lys | K |
| Methionine | Met | M |
| Phenylalanine | Phe | F |
| Proline | Pro | P |
| Serine | Ser | S |
| Threonine | Thr | T |
| Tryptophan | Trp | W |
| Tyrosine | Tyr | Y |
| Valine | Val | V |

“Gene” refers to a nucleic acid fragment that expresses a specific protein, including regulatory sequences preceding (5′ non-coding sequences) and following (3′ non-coding sequences) the coding sequence. “Native gene” refers to a gene as found in nature with its own regulatory sequences. “Chimeric gene” refers to any gene that is not a native gene, comprising regulatory and coding sequences that are not found together in nature. Accordingly, a chimeric gene may comprise regulatory sequences and coding sequences that are derived from different sources, or regulatory sequences and coding sequences derived from the same source, but arranged in a manner different than that found in nature. A “foreign” gene refers to a gene not normally found in the host organism, but that is introduced into the host organism by gene transfer. Foreign genes can comprise native genes inserted into a non-native organism, or chimeric genes.

“Synthetic genes” can be assembled from oligonucleotide building blocks that are chemically synthesized using procedures known to those skilled in the art. These building blocks are ligated and annealed to form gene segments which are then enzymatically assembled to construct the entire gene. “Chemically synthesized”, as related to a sequence of DNA, means that the component nucleotides were assembled in vitro. Manual chemical synthesis of DNA may be accomplished using well-established procedures, or automated chemical synthesis can be performed using one of a number of commercially available machines. Accordingly, the genes can be tailored for optimal gene expression based on optimization of nucleotide sequence to reflect the codon bias of the host cell. The skilled artisan appreciates the likelihood of successful gene expression if codon usage is biased towards those codons favored by the host. Determination of preferred codons can be based on a survey of genes derived from the host cell where sequence information is available.

“Coding sequence” refers to a DNA sequence that codes for a specific amino acid sequence. “Suitable regulatory sequences” refer to nucleotide sequences located upstream (5′ non-coding sequences), within, or downstream (3′ non-coding sequences) of a coding sequence, and which influence the transcription, RNA processing or stability, or translation of the associated coding sequence. Regulatory sequences may include promoters, translation leader sequences, introns, polyadenylation recognition sequences, RNA processing site, effector binding site and stem-loop structure.

“Promoter” refers to a DNA sequence capable of controlling the expression of a coding sequence or functional RNA. In general, a coding sequence is located 3′ to a promoter sequence. Promoters may be derived in their entirety from a native gene, or be composed of different elements derived from different promoters found in nature, or even comprise synthetic DNA segments. It is understood by those skilled in the art that different promoters may direct the expression of a gene in different tissues or cell types, or at different stages of development, or in response to different environmental or physiological conditions. Promoters which cause a gene to be expressed in most cell types at most times are commonly referred to as “constitutive promoters”. It is further recognized that since in most cases the exact boundaries of regulatory sequences have not been completely defined, DNA fragments of different lengths may have identical promoter activity.

The term “expression”, as used herein, refers to the transcription and stable accumulation of sense (mRNA) or antisense RNA derived from the nucleic acid fragment of the invention. Expression may also refer to translation of mRNA into a polypeptide.

The term “transformation” refers to the transfer of a nucleic acid fragment into the genome of a host organism, resulting in genetically stable inheritance. Host organisms containing the transformed nucleic acid fragments are referred to as “transgenic” or “recombinant” or “transformed” organisms.

The term “host cell” refers to cell which has been transformed or transfected, or is capable of transformation or transfection by an exogenous polynucleotide sequence.

The terms “plasmid”, “vector” and “cassette” refer to an extra chromosomal element often carrying genes which are not part of the central metabolism of the cell, and usually in the form of circular double-stranded DNA molecules. Such elements may be autonomously replicating sequences, genome integrating sequences, phage or nucleotide sequences, linear or circular, of a single- or double-stranded DNA or RNA, derived from any source, in which a number of nucleotide sequences have been joined or recombined into a unique construction which is capable of introducing a promoter fragment and DNA sequence for a selected gene product along with appropriate 3′ untranslated sequence into a cell. “Transformation cassette” refers to a specific vector containing a foreign gene and having elements in addition to the foreign gene that facilitate transformation of a particular host cell. “Expression cassette” refers to a specific vector containing a foreign gene and having elements in addition to the foreign gene that allow for enhanced expression of that gene in a foreign host.

The term “phage” or “bacteriophage” refers to a virus that infects bacteria. Altered forms may be used for the purpose of the present invention. The preferred bacteriophage is derived from the “wild” phage, called M13. The M13 system can grow inside a bacterium, so that it does not destroy the cell it infects but causes it to make new phages continuously. It is a single-stranded DNA phage.

The term “phage display” refers to the display of functional foreign peptides or small proteins on the surface of bacteriophage or phagemid particles. Genetically engineered phage may be used to present peptides as segments of their native surface proteins. Peptide libraries may be produced by populations of phage with different gene sequences.

“PCR” or “polymerase chain reaction” is a technique used for the amplification of specific DNA segments (U.S. Pat. Nos. 4,683,195 and 4,800,159).

Standard recombinant DNA and molecular cloning techniques used herein are well known in the art and are described by Sambrook, J., Fritsch, E. F. and Maniatis, T., Molecular Cloning: A Laboratory Manual, Second Edition, Cold Spring Harbor Laboratory Press, Cold Spring Harbor, N.Y. (1989) (hereinafter “Maniatis”); and by Silhavy, T. J., Bennan, M. L. and Enquist, L. W., Experiments with Gene Fusions, Cold Spring Harbor Laboratory Cold Press Spring Harbor, N.Y. (1984); and by Ausubel, F. M. et al., Current Protocols in Molecular Biology, published by Greene Publishing Assoc. and Wiley-Interscience (1987).

The invention provides a method for identifying skin care composition-resistant peptide sequences that bind specifically to skin with high affinity in the presence of a skin care composition matrix. The method is a modification of standard biopanning techniques wherein skin is contacted with a library of combinatorially generated peptides. Then, the resulting DNA associated peptide-skin complexes are contacted with a skin care composition matrix for a period of time. The DNA associated peptide-skin complexes are isolated and contacted with an eluting agent to give eluted DNA associated peptides and DNA associated peptides that remain bound to the skin. The eluted DNA associated peptides and/or the remaining bound DNA associated peptides are amplified and identified. The identified skin care composition-resistant skin-binding peptide sequences may be used to construct peptide-based skin benefit agents, such as skin conditioners and skin colorants.

Identification of Skin Care Composition-Resistant Skin-Binding Peptides

Skin care composition-resistant skin-binding peptides (SCP), as defined herein, are peptide sequences that specifically bind to skin from a skin care composition matrix and are stable therein. The skin care composition-resistant skin-binding peptides of the invention are from about 7 amino acids to about 45 amino acids in length, more preferably, from about 7 amino acids to about 25 amino acids in length, most preferably from about 12 to about 20 amino acids in length. The peptides of the present invention are generated randomly and then selected against a skin sample based on their binding affinity to skin in the presence of a skin care composition matrix, as described below.

The generation of random libraries of peptides is well known and may be accomplished by a variety of techniques including, bacterial display (Kemp, D. J.; Proc. Natl. Acad. Sci. USA 78(7):4520-4524 (1981), and Helfman et al., Proc. Natl. Acad. Sci. USA 80(1):31-35, (1983)), yeast display (Chien et al., Proc Natl Acad Sci USA. 88(21):9578-82 (1991)), combinatorial solid phase peptide synthesis (U.S. Pat. No. 5,449,754, U.S. Pat. No. 5,480,971, U.S. Pat. No. 5,585,275, U.S. Pat. No. 5,639,603), and phage display technology (U.S. Pat. No. 5,223,409, U.S. Pat. No. 5,403,484, U.S. Pat. No. 5,571,698, U.S. Pat. No. 5,837,500). Techniques to generate such biological peptide libraries are well known in the art. Exemplary methods are described in Dani, M., J. of Receptor & Signal Transduction Res., 21 (4):447-468 (2001), Sidhu et al., Methods in Enzymology 328:333-363 (2000), and Phage Display of Peptides and Proteins, A Laboratory Manual, Brian K. Kay, Jill Winter, and John McCafferty, eds.; Academic Press, NY, 1996. Additionally, phage display libraries may be purchased from commercial sources, such as New England Biolabs (Beverly, Mass.).

In one embodiment it is particularly useful to have the DNA encoding the peptide associated with the peptide in some manner. This association facilitates rapid identification of the binding peptide in the screening or biopanning process. The coding DNA may be either PCR amplified or used to infect a replicating host to increase the expression of the peptide for facile identification. Typically DNA associated peptides are produced by the methods of phage display, bacteria display and yeast display as referenced above.

A preferred method to randomly generate peptides is by phage display. Phage display is an in vitro selection technique in which a peptide or protein is genetically fused to a coat protein of a bacteriophage, resulting in display of fused peptide on the exterior of the phage virion, while the DNA encoding the fusion resides within the virion. This physical linkage between the displayed peptide and the DNA encoding it allows screening of vast numbers of variants of peptides, each linked to a corresponding DNA sequence, by a simple in vitro selection procedure called “biopanning”. In its simplest form, biopanning is carried out by incubating the pool of phage-displayed variants with a target of interest, washing away unbound phage, and eluting specifically bound phage by disrupting the binding interactions between the phage and the target. The eluted phage is then amplified in vivo and the process is repeated, resulting in a stepwise enrichment of the phage pool in favor of the tightest binding sequences. After 3 or more rounds of selection/amplification, individual clones are characterized by DNA sequencing.

The skin care composition-resistant skin-binding peptides of the invention may be identified using phage display by selecting phage peptides against a skin sample based upon their binding affinity for the skin in the presence of a skin composition matrix. The skin and the phage peptides may be contacted with the skin composition matrix in various ways to form a peptide-skin complex-composition mixture, as described in detail below. For example, the phage peptide library may be dissolved in the skin composition matrix which is then contacted with the skin sample. Alternatively, the phage-peptide-skin complex, formed by contacting the skin sample with the phage display library, may be subsequently contacted with a skin composition matrix. Additionally, any combination of these skin composition matrix-contacting methods may be used.

After a suitable library of DNA associated peptides has been generated or purchased from a commercial supplier, the library is contacted with an appropriate amount of skin sample to form a reaction solution comprising DNA associated peptide-skin complexes. Human skin samples may be obtained from cadavers or in vitro human skin cultures. Additionally, pig skin, Vitro-Skin® (available from IMS Inc., Milford, Conn.) and EpiDerm™ (available from MatTek Corp., Ashland, Mass.) may be used as substitutes for human skin. The library of DNA associated peptides is dissolved in a suitable solution for contacting the skin sample. In one embodiment, the library of peptides is dissolved in a buffered aqueous saline solution containing a surfactant. A suitable solution is Tris-buffered saline (TBS) with 0.5% Tween® 20. In another embodiment, the library of peptides is dissolved in a skin care composition matrix (see below) and then contacted with the skin sample. The solution may be agitated by any means in order to increase the mass transfer rate of the peptides to the skin surface, thereby shortening the time required to attain maximum binding. The time required to attain maximum binding varies depending on a number of factors, such as size of the skin sample, the concentration of the peptide library, and the agitation rate. The time required can be determined readily by one skilled in the art using routine experimentation. Typically, the contact time is one minute to one hour. Optionally, the library of peptides may be contacted with a non-target, such as hair or plastic, either prior to or simultaneously with contacting the skin sample to remove the undesired DNA associated peptides that bind to the non-target.

Upon contact with the skin sample, a number of the randomly generated peptides bind to the skin to form DNA associated peptide-skin complexes. A number of peptides remain uncomplexed and portions of the skin sample are also unbound. Uncomplexed peptides may optionally be removed by washing using any suitable buffer solution, such as Tris-HCl, Tris-buffered saline, Tris-borate, Tris-acetic acid, triethylamine, phosphate buffer, and glycine-HCl, wherein Tris-buffered saline solution is preferred. The wash solution may also contain a surfactant such as SDS (sodium dodecyl sulfate), DOC (sodium deoxycholate), Nonidet P40, Triton X-100, and Tween® 20, wherein Tween® 20 at a concentration of 0.5% is preferred. The wash step may be repeated one or more times.

After the uncomplexed material is removed, the DNA associated peptide-skin complexes are contacted with a skin care composition matrix for a period of time, typically, about 1 minute to about 30 minutes to form a peptide-skin complex-composition mixture. A skin care composition matrix, as used herein, refers to a medium comprising a skin care product, such as skin conditioners, skin cleansers, make-up, anti-wrinkle products and skin colorants, either undiluted or in diluted form, or a mixture comprising at least one component of a skin care product, in addition, at least two components of a skin care product. Suitable skin care product compositions are well known in the art. Skin care compositions are described by Philippe et al. in U.S. Pat. No. 6,280,747. For example, the skin care composition may be an anhydrous composition containing a fatty substance in a proportion generally of from about 10 to about 90% by weight relative to the total weight of the composition, where the fatty phase containing at least one liquid, solid or semi-solid fatty substance. The fatty substance includes, but is not limited to, oils, waxes, gums, and so-called pasty fatty substances. Alternatively, the compositions may be in the form of a stable dispersion such as a water-in-oil or oil-in-water emulsion. Additionally, the compositions may contain one or more conventional cosmetic or dermatological additives or adjuvants, including but not limited to, skin conditioning agents (see below for examples), skin colorants (see below for examples), antioxidants, preserving agents, fillers, surfactants, UVA and/or UVB sunscreens, fragrances, thickeners, wetting agents and anionic, nonionic or amphoteric polymers, and dyes or pigments. Commercially available skin care products from companies such as L'Oreal, Neutrogena, Proctor and Gamble, Unilever, and Johnson and Johnson may be used. These skin care products may be purchased at local supermarkets and pharmacies. Preferably, the skin care composition matrix in which the skin care composition-resistant skin-binding peptide will ultimately be employed, is used in the method. The skin care composition matrix may be used undiluted or may be diluted to facilitate its application, particularly in the case of a very viscous composition. The skin care composition may be diluted with water or a suitable buffer solution, such as that described above, may be used. The concentration of the skin care composition matrix is at least about 10%, preferably at least about 20%, more preferably at least about 50%, more preferably at least about 75% of the full strength concentration. Most preferably, the skin care composition matrix is used in undiluted form. Optionally, the DNA associated peptide-skin complexes may be contacted with the skin care composition matrix one or more times.

In one embodiment, the skin care composition matrix comprises a skin conditioning product. In another embodiment, the skin care composition matrix comprises a skin cleansing product.

The DNA associated peptide-skin complexes are isolated from the peptide-skin complex-composition mixture and are optionally washed one or more times using a buffer solution, as described above. The skin care composition matrix may also be used as the wash solution. The DNA associated peptide-skin complexes are then contacted with an eluting agent for a period of time, typically 1 to 30 minutes, to dissociate the DNA associated peptides from the skin; however, some of the DNA associated peptides may still remain bound to the skin after this treatment. Optionally, the DNA associated peptide-skin complexes are transferred to a new container before contacting with the eluting agent. The eluting agent may be any known eluting agent including, but not limited to, acid (pH 1.5-3.0); base (pH 10-12.5); high salt concentrations such as MgCl₂ (3-5 M) and LiCl (5-10 M); water; ethylene glycol (25-50%); dioxane (5-20%); thiocyanate (1-5 M); guanidine (2-5 M); and urea (2-8 M), wherein treatment with an acid is preferred. If the elution buffer used is an acid or base, then a neutralization buffer is added to adjust the pH to the neutral range after the elution step. Any suitable buffer may be used, wherein 1 M Tris-HCl pH 9.2 is preferred for use with an acid elution buffer.

The DNA encoding the eluted peptides or the remaining bound peptides, or the DNA encoding both the eluted peptides and the remaining bound peptides is then amplified using methods known in the art. For example, the DNA encoding the eluted peptides and the remaining bound peptides may be amplified by infecting a bacterial host cell, such as E. coli ER2738, with the DNA encoding the desired peptide, as described by Huang et al. (copending and commonly owned U.S. Patent Application Publication No. 2005/0050656, incorporated herein by reference). The infected host cells are grown in an appropriate growth medium, such as LB (Luria-Bertani) medium, and this culture is spread onto agar, containing a suitable growth medium, such as LB medium with IPTG (isopropyl β-D-thiogalactopyranoside) and S-Gal™ (3,4-cyclohexenoesculetin-β-D-galactopyranoside). After growth, the plaques are picked for DNA isolation and sequencing to identify the skin care composition-resistant skin-binding peptide sequences. Alternatively, the DNA encoding the eluted peptides and the remaining bound peptides may be amplified using a nucleic acid amplification method, such as the polymerase chain reaction (PCR). In that approach, PCR is carried out on the DNA encoding the eluted peptides and/or the remaining bound peptides using the appropriate primers, as described by Janssen et al. in U.S. Patent Application Publication No. 2003/0152976, which is incorporated herein by reference.

In one embodiment, the DNA encoding the eluted peptides and the remaining bound peptides are amplified by infecting a bacterial host cell, the amplified DNA associated peptides are contacted with a fresh skin sample, and the entire process described above is repeated one or more times to obtain a population that is enriched in skin care composition-resistant skin-binding DNA associated peptides. After the desired number of biopanning cycles, the amplified DNA sequences are determined using standard DNA sequencing techniques that are well known in the art to identify the skin care composition-resistant skin-binding peptide sequences.

Production of Skin Care Composition-Resistant Skin-Binding Peptides

The skin care composition-resistant skin-binding peptides of the present invention may be prepared using standard peptide synthesis methods, which are well known in the art (see for example Stewart et al., Solid Phase Peptide Synthesis, Pierce Chemical Co., Rockford, Ill., 1984; Bodanszky, Principles of Peptide Synthesis, Springer-Verlag, New York, 1984; and Pennington et al., Peptide Synthesis Protocols, Humana Press, Totowa, N.J., 1994). Additionally, many companies offer custom peptide synthesis services.

Alternatively, the peptides of the present invention may be prepared using recombinant DNA and molecular cloning techniques. Genes encoding skin-binding peptides may be produced in heterologous host cells, particularly in the cells of microbial hosts.

Preferred heterologous host cells for expression of the binding peptides of the present invention are microbial hosts that can be found broadly within the fungal or bacterial families and which grow over a wide range of temperature, pH values, and solvent tolerances. Because transcription, translation, and the protein biosynthetic apparatus are the same irrespective of the cellular feedstock, functional genes are expressed irrespective of carbon feedstock used to generate cellular biomass. Examples of host strains include, but are not limited to, fungal or yeast species such as Aspergillus, Trichoderma, Saccharomyces, Pichia, Candida, Hansenula, or bacterial species such as Salmonella, Bacillus, Acinetobacter, Rhodococcus, Streptomyces, Escherichia, Pseudomonas, Methylomonas, Methylobacter, Alcaligenes, Synechocystis, Anabaena, Thiobacillus, Methanobacterium and Klebsiella.

A variety of expression systems can be used to produce the peptides of the present invention. Such vectors include, but are not limited to, chromosomal, episomal and virus-derived vectors, e.g., vectors derived from bacterial plasmids, from bacteriophage, from transposons, from insertion elements, from yeast episoms, from viruses such as baculoviruses, retroviruses and vectors derived from combinations thereof such as those derived from plasmid and bacteriophage genetic elements, such as cosmids and phagemids. The expression system constructs may contain regulatory regions that regulate as well as engender expression. In general, any system or vector suitable to maintain, propagate or express polynucleotide or polypeptide in a host cell may be used for expression in this regard. Microbial expression systems and expression vectors contain regulatory sequences that direct high level expression of foreign proteins relative to the growth of the host cell. Regulatory sequences are well known to those skilled in the art and examples include, but are not limited to, those which cause the expression of a gene to be turned on or off in response to a chemical or physical stimulus, including the presence of regulatory elements in the vector, for example, enhancer sequences. Any of these could be used to construct chimeric genes for production of the any of the binding peptides of the present invention. These chimeric genes could then be introduced into appropriate microorganisms via transformation to provide high level expression of the peptides.

Vectors or cassettes useful for the transformation of suitable host cells are well known in the art. Typically the vector or cassette contains sequences directing transcription and translation of the relevant gene, one or more selectable markers, and sequences allowing autonomous replication or chromosomal integration. Suitable vectors comprise a region 5′ of the gene, which harbors transcriptional initiation controls and a region 3′ of the DNA fragment which controls transcriptional termination. It is most preferred when both control regions are derived from genes homologous to the transformed host cell, although it is to be understood that such control regions need not be derived from the genes native to the specific species chosen as a production host. Selectable marker genes provide a phenotypic trait for selection of the transformed host cells such as tetracycline or ampicillin resistance in E. coli.

Initiation control regions or promoters which are useful to drive expression of the chimeric gene in the desired host cell are numerous and familiar to those skilled in the art. Virtually any promoter capable of driving the gene is suitable for producing the binding peptides of the present invention including, but not limited to: CYC1, HIS3, GAL1, GAL10, ADH1, PGK, PHO5, GAPDH, ADC1, TRP1, URA3, LEU2, ENO, TPI (useful for expression in Saccharomyces); AOX1 (useful for expression in Pichia); and lac, ara, tet, trp, IP_{L}, IP_{R}, T7, tac, and trc (useful for expression in Escherichia coli) as well as the amy, apr, npr promoters and various phage promoters useful for expression in Bacillus.

Termination control regions may also be derived from various genes native to the preferred hosts. Optionally, a termination site may be unnecessary, however, it is most preferred if included.

The vector containing the appropriate DNA sequence as described supra, as well as an appropriate promoter or control sequence, may be employed to transform an appropriate host to permit the host to express the peptide of the present invention. Cell-free translation systems can also be employed to produce such peptides using RNAs derived from the DNA constructs of the present invention. Optionally it may be desired to produce the instant gene product as a secretion product of the transformed host. Secretion of desired proteins into the growth media has the advantages of simplified and less costly purification procedures. It is well known in the art that secretion signal sequences are often useful in facilitating the active transport of expressible proteins across cell membranes. The creation of a transformed host capable of secretion may be accomplished by the incorporation of a DNA sequence that codes for a secretion signal which is functional in the production host. Methods for choosing appropriate signal sequences are well known in the art (see for example EP 546049 and WO 9324631). The secretion signal DNA or facilitator may be located between the expression-controlling DNA and the instant gene or gene fragment, and in the same reading frame with the latter.

Peptide-Based Skin Benefit Agents

The peptide-based skin benefit agents of the invention are formed by coupling a skin care composition-resistant skin-binding peptide (SCP) with a benefit agent (BA), such as a conditioner, colorant, fragrance, sunscreen, and the like. The skin care composition-resistant skin-binding peptide part of the peptide-based benefit agent binds strongly to the skin from a skin care composition matrix, thus keeping the benefit agent attached to the skin for a long lasting effect. The coupling interaction between the skin care composition-resistant skin-binding peptide and the benefit agent may be a covalent bond or a non-covalent interaction and may be through an optional spacer, as described below.

It may also be desirable to have multiple skin care composition-resistant skin-binding peptides coupled to the benefit agent to enhance the interaction between the peptide-based benefit agent and the skin, as described by Huang et al., (copending and commonly owned U.S. Patent Application Publication No. 2005/0050656). This may be done by coupling multiple copies of single skin care composition-resistant skin-binding peptide sequences to the benefit agent or by linking two or more skin care composition-resistant skin-binding peptide sequences together, either directly or through a spacer, and coupling the resulting multi-copy skin-binding sequence to the benefit agent. Additionally, multiple copies of the multi-copy skin care composition-resistant skin-binding peptide sequence may be coupled to the benefit agent. In all these peptide-based skin benefit agents, multiple copies of the same skin care composition-resistant skin-binding peptide or a combination of different skin care composition-resistant skin-binding peptides may be used.

In one embodiment of the present invention, the peptide-based benefit agents are diblock compositions consisting of a skin care composition-resistant skin-binding peptide (SCP) and a benefit agent (BA), having the general structure (SCPₘ)ₙ−BA, where m ranges from 1 to about 100, preferably from 1 to about 10. When the benefit agent is a molecular species, n ranges from 1 to about 100, preferably from 1 to about 10. When the benefit agent is a particle, such as a pigment, n ranges from 1 to about 50,000, preferably from 1 to about 10,000.

In another embodiment, the peptide-based benefit agents contain a spacer (S) separating the skin care composition-resistant skin-binding peptide from the benefit agent. Multiple copies of the skin care composition-resistant skin-binding peptide may be coupled to a single spacer molecule. Alternatively, multiple copies of skin care composition-resistant skin-binding peptides may be separated by various spacers. In this embodiment, the peptide-based benefit agents are triblock compositions consisting of a skin care composition-resistant skin-binding peptide, a spacer, and a benefit agent, having the general structure [(SCPₓ−S)ₘ]ₙ−BA, where x ranges from 1 to about 10, preferably x is 1, and m ranges from 1 to about 100, preferably from 1 to about 10. When the benefit agent is a molecular species, such as a dye or non-particle conditioning agent, n ranges from 1 to about 100, preferably from 1 to about 10. When the benefit agent is a particle, such as a pigment, n ranges from 1 to about 50,000, preferably from 1 to about 10,000.

It should be understood that as used herein, SCP is a generic designation and is not meant to refer to a single skin care composition-resistant skin-binding peptide sequence. Where m, n or x as used above, is greater than 1, it is well within the scope of the invention to provide for the situation where a series of skin-binding peptides of different sequences may form a part of the composition. Additionally, S is a generic term and is not meant to refer to a single spacer. Where m and n, as used above for the triblock compositions, is greater than 1, it is well within the scope of the invention to provide for the situation where a series of different spacers may form a part of the composition it should also be understood that these structures do not necessarily represent a covalent bond between the peptide, the benefit agent, and the optional spacer. As described below, the coupling interaction between the peptide, the benefit agent, and the optional spacer may be either covalent or non-covalent.

The preparation of the skin care composition-resistant skin-binding peptide-based benefit agents of the invention is described below for skin conditioner and skin colorants. It should be understood that these methods may be applied to other benefit agents and that these other skin care composition-resistant skin-binding peptide-based benefit agents are within the scope of the invention.

Peptide-Based Skin Conditioners

The peptide-based skin conditioners of the invention are formed by coupling a skin care composition-resistant skin-binding peptide (SCP) with a skin conditioning agent (SCA). The skin care composition-resistant skin-binding peptide part of the conditioner binds strongly to the skin from the skin care composition matrix, thus keeping the conditioning agent attached to the skin for a long lasting conditioning effect. The skin care composition-resistant skin-binding peptides are identified using the methods described above.

Skin conditioning agents as herein defined include, but are not limited to, astringents, which tighten skin; exfoliants, which remove dead skin cells; emollients, which help maintain a smooth, soft, pliable appearance; humectants, which increase the water content of the top layer of skin; occlusives, which retard evaporation of water from the skin's surface; health promoting agents, and miscellaneous compounds that enhance the appearance of dry or damaged skin or reduce flaking and restore suppleness. In the peptide-based skin conditioners of the present invention, any suitable known skin conditioning agent may be used. Skin conditioning agents are well known in the art, see for example Green et al. (WO 0107009), incorporated herein by reference, and are available commercially from various sources. Suitable examples of skin conditioning agents include, but are not limited to, alpha-hydroxy acids, beta-hydroxy acids, polyols, hyaluronic acid, D,L-panthenol, polysalicylates, vitamin A palmitate, vitamin E acetate, glycerin, sorbitol, silicones, silicone derivatives, lanolin, natural oils, triglyceride esters, gamma aminobutyric acid, hormones, such as human growth hormone; and insulin-like growth factor-I. The preferred skin conditioning agents of the present invention are polysalicylates, propylene glycol (CAS No. 57-55-6, Dow Chemical, Midland, Mich.), glycerin (CAS No. 56-81-5, Proctor & Gamble Co., Cincinnati, Ohio), glycolic acid (CAS No. 79-14-1, DuPont Co., Wilmington, Del.), lactic acid (CAS No. 50-21-5, Alfa Aesar, Ward Hill, Mass.), malic acid (CAS No. 617-48-1, Alfa Aesar), citric acid (CAS No. 77-92-9, Alfa Aesar), tartaric acid (CAS NO. 133-37-9, Alfa Aesar), glucaric acid (CAS No. 87-73-0), galactaric acid (CAS No. 526-99-8), 3-hydroxyvaleric acid (CAS No. 10237-77-1), salicylic acid (CAS No. 69-72-7, Alfa Aesar), and 1,3 propanediol (CAS No. 504-63-2, DuPont Co., Wilmington, Del.). Polysalicylates may be prepared by the method described by White et al. in U.S. Pat. No. 4,855,483, incorporated herein by reference. Glucaric acid may be synthesized using the method described by Merbouh et al. (Carbohydr. Res. 336:75-78 (2001). The 3-hydroxyvaleric acid may be prepared as described by Bramucci in WO 02/012530.

The peptide-based skin conditioners of the present invention are prepared by coupling a specific skin care composition-resistant skin-binding peptide to the skin conditioning agent, either directly or via an optional spacer. The coupling interaction may be a covalent bond or a non-covalent interaction, such as hydrogen bonding, electrostatic interaction, hydrophobic interaction, or Van der Waals interaction. In the case of a non-covalent interaction, the peptide-based skin conditioner may be prepared by mixing the peptide with the conditioning agent and the optional spacer (if used) and allowing sufficient time for the interaction to occur. The unbound materials may be separated from the resulting peptide-based skin conditioner adduct using methods known in the art, for example, gel permeation chromatography.

The peptide-based skin conditioners of the invention may also be prepared by covalently attaching a specific skin care composition-resistant skin-binding peptide to a skin conditioning agent, either directly or through a spacer, as described by Huang et al. (copending and commonly owned U.S. Patent Application Publication No. 2005/0050656). Any suitable known peptide or protein conjugation chemistry may be used to form the peptide-based skin conditioners of the present invention. Conjugation chemistries are well-known in the art (see for example, Hermanson, Bioconjugate Techniques, Academic Press, New York (1996)). Suitable coupling agents include, but are not limited to, carbodiimide coupling agents, acid chlorides, isocyanates, epoxides, maleimides, and other functional coupling reagents that are reactive toward terminal amine and/or carboxylic acid groups, and sulfhydryl groups on the peptides and to amine, carboxylic acid, or alcohol groups on the skin conditioning agent. Additionally, it may be necessary to protect reactive amine or carboxylic acid groups on the peptide to produce the desired structure for the peptide-based skin conditioner. The use of protecting groups for amino acids, such as t-butyloxycarbonyl (t-Boc), are well known in the art (see for example Stewart et al., supra; Bodanszky, supra; and Pennington et al., supra). In some cases it may be necessary to introduce reactive groups, such as carboxylic acid, alcohol, amine, isocyanate, or aldehyde groups, on the skin conditioning agent for coupling to the skin-binding peptide. These modifications may be done using routine chemistry such as oxidation, reduction, phosgenation, and the like, which is well known in the art.

It may also be desirable to couple the skin care composition-resistant skin-binding peptide to the skin conditioning agent via a spacer. The spacer serves to separate the conditioning agent from the peptide to ensure that the agent does not interfere with the binding of the peptide to the skin. The spacer may be any of a variety of molecules, such as alkyl chains, phenyl compounds, ethylene glycol, amides, esters and the like. Preferred spacers are hydrophilic and have a chain length from 1 to about 100 atoms, more preferably, from 2 to about 30 atoms. Examples of preferred spacers include, but are not limited to ethanol amine, ethylene glycol, polyethylene with a chain length of 6 carbon atoms, polyethylene glycol with 3 to 6 repeating units, phenoxyethanol, propanolamide, butylene glycol, butyleneglycolamide, propyl phenyl, and ethyl, propyl, hexyl, steryl, cetyl, and palmitoyl alkyl chains. The spacer may be covalently attached to the peptide and the skin conditioning agent using any of the coupling chemistries described above. In order to facilitate incorporation of the spacer, a bifunctional cross-linking agent that contains a spacer and reactive groups at both ends for coupling to the peptide and the conditioning agent may be used. Suitable bifunctional cross-linking agents are well known in the art and include, but are not limited to diamines, such a as 1,6-diaminohexane; dialdehydes, such as glutaraldehyde; bis N-hydroxysuccinimide esters, such as ethylene glycol-bis(succinic acid N-hydroxysuccinimide ester), disuccinimidyl glutarate, disuccinimidyl suberate, and ethylene glycol-bis(succinimidylsuccinate); diisocyanates, such as hexamethylenediisocyanate; bis oxiranes, such as 1,4 butanediyl diglycidyl ether; dicarboxylic acids, such as succinyldisalicylate; and the like. Heterobifunctional cross-linking agents, which contain a different reactive group at each end, may also be used. Examples of heterobifunctional cross-linking agents include, but are not limited to compounds having the following structure: 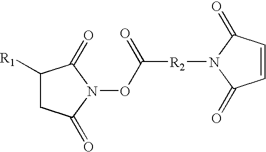
where: R₁ is H or a substituent group such as —SO₃Na, —NO₂, or —Br; and R₂ is a spacer such as —CH₂CH₂ (ethyl), —(CH₂)₃ (propyl), or —(CH₂)₃C₆H₅ (propyl phenyl). An example of such a heterobifunctional cross-linking agent is 3-maleimidopropionic acid N-hydroxysuccinimide ester. The N-hydroxysuccinimide ester group of these reagents reacts with amine or alcohol groups on the conditioner, while the maleimide group reacts with thiol groups present on the peptide. A thiol group may be incorporated into the peptide by adding at least one cysteine group to at least one end of the binding peptide sequence, i.e., the C-terminal end or the N-terminal end. Several spacer amino acid residues, such as glycine, may be incorporated between the binding peptide sequence and the terminal cysteine to separate the reacting thiol group from the binding sequence. Moreover, at least one lysine residue may be added to at least one end of the binding peptide sequence, i.e., the C-terminal end or the N-terminal end, to provide an amine group for coupling.

Additionally, the spacer may be a peptide comprising any amino acid and mixtures thereof. The preferred peptide spacers comprise the amino acids proline, lysine, glycine, alanine, and serine, and mixtures thereof. In addition, the peptide spacer may contain a specific enzyme cleavage site, such as the protease Caspase 3 site, given by SEQ ID NO:1, which allows for the enzymatic removal of the conditioning agent from the skin. The peptide spacer may be from 1 to about 50 amino acids, preferably from 1 to about 20 amino acids in length. Examples of peptide spacers include, but are not limited to, SEQ ID NOs:5-7. These peptide spacers may be linked to the binding peptide sequence by any method know in the art. For example, the entire binding peptide-peptide spacer-diblock may be prepared using the standard peptide synthesis methods described supra. In addition, the binding peptide and peptide spacer blocks may be combined using carbodiimide coupling agents (see for example, Hermanson, Bioconjugate Techniques, Academic Press, New York (1996)), diacid chlorides, diisocyanates and other difunctional coupling reagents that are reactive to terminal amine and/or carboxylic acid on the peptides. Alternatively, the entire binding peptide-peptide spacer-diblock may be prepared using the recombinant DNA and molecular cloning techniques described supra. The spacer may also be a combination of a peptide spacer and an organic spacer molecule, which may be prepared using the methods described above.

It may also be desirable to have multiple skin care composition-resistant skin-binding peptides coupled to the skin conditioning agent to enhance the interaction between the peptide-based skin conditioner and the skin. Either multiple copies of the same skin-binding peptide or a combination of different skin-binding peptides may be used. In the case of large conditioning particles (e.g. particle emulsions), a large number of skin-binding peptides, i.e., up to about 50,000, may be coupled to the conditioning agent. A smaller number of skin-binding peptides can be coupled to the smaller conditioner molecules, i.e., up to about 100. Additionally, multiple copies of the peptides may be linked together and coupled to the skin conditioning agent. Therefore, in one embodiment of the present invention, the peptide-based skin conditioners are diblock compositions consisting of a skin care composition-resistant skin-binding peptide (SCP) and a skin conditioning agent (SCA), having the general structure (SCPₘ)ₙ−SCA, where m ranges from 1 to about 100, preferably from 1 to about 10. When the conditioning agent is a molecular species, n ranges from 1 to about 100, preferably from 1 to about 10. When the conditioning agent is a particle, n ranges from 1 to about 50,000, preferably from 1 to about 10,000.

In another embodiment, the peptide-based skin conditioners contain a spacer (S) separating the skin care composition-resistant skin-binding peptide from the skin conditioning agent, as described above. Multiple copies of the skin-binding peptide may be coupled to a single spacer molecule. Additionally, multiple copies of the peptides may be linked together via spacers and coupled to the skin conditioning agent via a spacer. In this embodiment, the peptide-based skin conditioners are triblock compositions consisting of a skin care composition-resistant skin-binding peptide, a spacer, and a skin conditioning agent, having the general structure [(SCPₓ−S)ₘ]ₙ−SCA, where x ranges from 1 to about 10, preferably x is 1, and m ranges from 1 to about 100, preferably m is 1 to about 10. When the skin conditioning agent is a molecular species, i.e., a non-particle conditioning agent, n ranges from 1 to about 100, preferably from 1 to about 10. When the skin conditioning agent is a particle, n ranges from 1 to about 50,000, preferably from 1 to about 10,000.

It should be understood that as used herein, SCP is a generic designation and is not meant to refer to a single skin-binding peptide sequence. Where m, n, or x as used above, is greater than 1, it is well within the scope of the invention to provide for the situation where a series of skin-binding peptides of different sequences may form a part of the composition. Additionally, S is a generic term and is not meant to refer to a single spacer. Where m and n, as used above for the triblock compositions, is greater than 1, it is well within the scope of the invention to provide for the situation where a series of different spacers may form a part of the composition. It should also be understood that these structures do not necessarily represent a covalent bond between the peptide, the skin conditioning agent, and the optional spacer. As described above, the coupling interaction between the peptide, the skin conditioning agent, and the optional spacer may be either covalent or non-covalent.

The peptide-based skin conditioners of the present invention may be used in products for skin care. It should also be recognized that the skin-binding peptides themselves can serve as conditioning agents for skin. Skin care product compositions include, but are not limited to, skin conditioners, skin cleansers, make-up, anti-wrinkle products and skin colorants. In one embodiment, the skin care product composition is a skin conditioning product. In another embodiment, the skin care product composition is a skin coloring product. In another embodiment, the skin care product composition is a skin cleansing product.

The skin care product compositions of the invention comprise an effective amount of a peptide-based skin conditioner or a mixture of different peptide-based skin conditioners in a cosmetically acceptable medium. An effective amount of a peptide-based skin conditioner or skin-binding peptide for skin care compositions is herein defined as a proportion of from about 0.001% to about 10%, preferably about 0.01% to about 5% by weight relative to the total weight of the composition. This proportion may vary as a function of the type of skin care product. Components of a cosmetically acceptable medium for skin care products are well known in the art and examples are described above.

Peptide-Based Skin Colorants

The peptide-based skin colorants of the present invention are formed by coupling a skin care composition-resistant skin-binding peptide (SCP) with a coloring agent (C). The skin care composition-resistant skin-binding peptide part of the peptide-based skin colorant binds strongly to the skin from a skin care composition matrix, thus keeping the coloring agent attached to the skin for a long lasting skin coloring effect. The skin care composition-resistant skin-binding peptides are identified using the methods described above.

The peptide-based skin colorants of the present invention are prepared by coupling a specific skin care composition-resistant skin-binding peptide to a coloring agent, either directly or via a spacer, using any of the coupling methods described above. Coloring agents as herein defined are any dye, pigment, and the like that may be used to change the color of skin. In the peptide-based skin colorants of the present invention, any suitable known coloring agent may be used. Coloring agents are well known in the art (see for example Green et al. supra, CFTA International Color Handbook, 2^{nd} ed., Micelle Press, England (1992) and Cosmetic Handbook, US Food and Drug Administration, FDA/IAS Booklet (1992)), and are available commercially from various sources (for example Bayer, Pittsburgh, Pa.; Ciba-Geigy, Tarrytown, N.Y.; ICI, Bridgewater, N.J.; Sandoz, Vienna, Austria; BASF, Mount Olive, N.J.; and Hoechst, Frankfurt, Germany). The preferred coloring agents for use in the peptide-based skin colorants of the present invention include the following dyes: eosin derivatives such as D&C Red No. 21 and halogenated fluorescein derivatives such as D&C Red No. 27, D&C Red Orange No. 5 in combination with D&C Red No. 21 and D&C Orange No. 10, and the pigments: titanium dioxide, zinc oxide, D&C Red No. 36 and D&C Orange No. 17, the calcium lakes of D&C Red Nos. 7, 11, 31 and 34, the barium lake of D&C Red No. 12, the strontium lake D&C Red No. 13, the aluminum lakes of FD&C Yellow No. 5, of FD&C Yellow No. 6, of D&C Red No. 27, of D&C Red No. 21, of FD&C Blue No. 1, iron oxides, manganese violet, chromium oxide, ultramarine blue, and carbon black. The coloring agent may also be a sunless tanning agent, such as dihydroxyacetone, that produces a tanned appearance on the skin without exposure to the sun.

Additionally, organic and inorganic nanoparticles, having an attached, adsorbed, or absorbed dye, may be used as a coloring agent. For example, the coloring agent may be colored polymer nanoparticles. Exemplary polymeric microspheres include, but are not limited to, microspheres of polystyrene, polymethylmethacrylate, polyvinyltoluene, styrene/butadiene copolymer, and latex. For use in the invention, the microspheres have a diameter of about 10 nanometers to about 2 microns. The microspheres may be colored by coupling any suitable dye, such as those described above, to the microspheres. The dyes may be coupled to the surface of the microsphere or adsorbed within the porous structure of a porous microsphere. Suitable microspheres, including undyed and dyed microspheres that are functionalized to enable covalent attachment, are available from companies such as Bang Laboratories (Fishers, Ind.).

It may also be desirable to have multiple skin care composition-resistant skin-binding peptides coupled to the coloring agent to enhance the interaction between the peptide-based skin colorant and the skin. Either multiple copies of the same skin-binding peptide or a combination of different skin-binding peptides may be used. Additionally, multiple skin-binding peptide sequences may be linked together and coupled to the coloring agent, as described above. In the case of large pigment particles, a large number of skin-binding peptides, i.e., up to about 50,000, may be coupled to the pigment. A smaller number of skin-binding peptides can be coupled to the smaller dye molecules, i.e., up to about 100. Therefore, in one embodiment of the present invention, the peptide-based skin colorants are diblock compositions consisting of a skin care composition-resistant skin-binding peptide (SCP) and a coloring agent (C), having the general structure (SCPₘ)ₙ−C, where m ranges from 1 to about 100, preferably m is 1 to about 10. When the coloring agent is a molecular species, such as a dye, n ranges from 1 to about 100, preferably from 1 to about 10. When the coloring agent is a particle, such as a pigment or nanoparticle, n ranges from 1 to about 50,000, preferably from 1 to about 10,000.

In another embodiment, the peptide-based skin colorants contain a spacer (S) separating the binding peptide from the coloring agent, as described above. Multiple copies of the skin-binding peptide may be coupled to a single spacer molecule. Additionally, multiple copies of the peptides may be linked together via spacers and coupled to the coloring agent via a spacer. In this embodiment, the peptide-based skin colorants are triblock compositions consisting of a skin care composition-resistant skin-binding peptide, a spacer, and a coloring agent, having the general structure [(SCPₓ−S)ₘ]ₙ−C, where x ranges from 1 to about 10, preferably x is 1, and m ranges from 1 to about 100, preferably m is 1 to about 10. When the coloring agent is a molecular species, such as a dye, n ranges from 1 to about 100, preferably from 1 to about 10. When the coloring agent is a particle, such as a pigment or nanoparticle, n ranges from 1 to about 50,000, preferably from 1 to about 10,000.

It should be understood that as used herein, SCP is a generic designation and is not meant to refer to a single skin-binding peptide sequence. Where m, n or x as used above, is greater than 1, it is well within the scope of the invention to provide for the situation where a series of skin-binding peptides of different sequences may form a part of the composition. Additionally, S is a generic term and is not meant to refer to a single spacer. Where m and n, as used above for the triblock compositions, is greater than 1, it is well within the scope of the invention to provide for the situation where a series of different spacers may form a part of the composition. It should also be understood that these structures do not necessarily represent a covalent bond between the peptide, the coloring agent, and the optional spacer. As described above, the coupling interaction between the peptide, the coloring agent, and the optional spacer may be either covalent or non-covalent.

The peptide-based skin colorants of the present invention may be used as coloring agents in cosmetic and make-up products, including but not limited to foundations, blushes, lipsticks, lip liners, lip glosses, eyeshadows and eyeliners. These may be anhydrous make-up products comprising a cosmetically acceptable medium which contains a fatty substance, or they may be in the form of a stable dispersion such as a water-in-oil or oil-in-water emulsion, as described above. In these compositions, the proportion of the peptide-based skin colorant is generally from about 0.001% to about 40% by weight relative to the total weight of the composition.

Methods for Treating Skin

In another embodiment, methods are provided for treating skin with the peptide-based conditioners and colorants of the present invention. Specifically, the present invention also comprises a method for forming a protective film of peptide-based conditioner on skin by applying one of the compositions described above comprising an effective amount of a peptide-based skin conditioner to the skin and allowing the formation of the protective film. The compositions of the present invention may be applied to the skin by various means, including, but not limited to, spraying, brushing, and applying by hand. The peptide-based conditioner composition is left in contact with the skin for a period of time sufficient to form the protective film, preferably for at least about 0.1 to 60 min.

The present invention also provides a method for coloring skin by applying a skin coloring composition comprising an effective amount of a peptide-based skin colorant to the skin by means described above.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations used is as follows: “min” means minute(s), “sec” means second(s), “h” means hour(s), “μL” means microliter(s), “mL” means milliliter(s), “L” means liter(s), “nm” means nanometer(s), “mm” means millimeter(s), “cm” means centimeter(s), “μm” means micrometer(s), “mM” means millimolar, “M” means molar, “mmol” means millimole(s), “μmol” means micromole(s), “g” means gram(s), “μg” means microgram(s), “mg” means milligram(s), “pfu” means plague forming unit, “BSA” means bovine serum albumin, “ELISA” means enzyme linked immunosorbent assay, “A” means absorbance, “A₄₅₀” means the absorbance measured at a wavelength of 450 nm, “TBS” means Tris-buffered saline, “TBST-X” means Tris-buffered saline containing Tween® 20 where “X” is the weight percent of Tween® 20, “SEM” means standard error of the mean, “THF” means tetrahydrofuran, “DMF” means dimethylformamide, “Mw” means weight-average molecular weight, “kDa” means kilodaltons, “NMR” means nuclear magnetic resonance spectroscopy, and “v/v” means volume-to-volume ratio.

General Methods:

Standard recombinant DNA and molecular cloning techniques are well known in the art and are described by Sambrook, J., Fritsch, E. F. and Maniatis, T., Molecular Cloning: A Laboratory Manual, Cold Spring Harbor Laboratory Press, Cold Spring Harbor, N.Y., 1989, by T. J. Silhavy, M. L. Bennan, and L. W. Enquist, Experiments with Gene Fusions, Cold Spring Harbor Laboratory, Cold Spring Harbor, N.Y., 1984, and by Ausubel, F. M. et al., Current Protocols in Molecular Biology, Greene Publishing Assoc. and Wiley-Interscience, N.Y., 1987.

Materials and methods suitable for the maintenance and growth of bacterial cultures are also well known in the art. Techniques suitable for use in the following Examples may be found in Manual of Methods for General Bacteriology, Phillipp Gerhardt, R. G. E. Murray, Ralph N. Costilow, Eugene W. Nester, Willis A. Wood, Noel R. Krieg and G. Briggs Phillips, eds., American Society for Microbiology, Washington, D.C., 1994, or by Thomas D. Brock in Biotechnology: A Textbook of Industrial Microbiology, Second Edition, Sinauer Associates, Inc., Sunderland, Mass., 1989. All reagents and materials described in the Examples for the growth and maintenance of bacterial cells may be obtained from Aldrich Chemicals (Milwaukee, Wis.), BD Diagnostic Systems (Sparks, Md.), Life Technologies (Rockville, Md.), or Sigma Chemical Company (St. Louis, Mo.), unless otherwise specified.

Phage Display Peptide Libraries:

Four phage display peptide libraries are used in the following Examples. The Ph.D.-12™ Phage Display Peptide Library is purchased from New England Biolabs (Beverly, Mass.). This kit is based on a combinatorial library of random peptide 12-mers fused to a minor coat protein (pIII) of M13 phage. The displayed peptide is expressed at the N-terminus of pIII, such that after the signal peptide is cleaved, the first residue of the coat protein is the first residue of the displayed peptide. The Ph.D.-12™ library consists of approximately 2.7×10⁹ sequences.

Three phage display peptide libraries, one containing 15-mer random peptide sequences, another containing 20-mer random peptide sequences, and a third containing 14-mer disulfide constrained random peptide sequences with a cystine residue at positions 3 and 11, are prepared using the method described by Kay et al. (Combinatorial Chemistry & High Throughput Screening, Vol. 8, 545-551 (2005)). This method is a modification of the method reported by Sidhu et al. (Methods in Enzymology 328:333-363 (2000)) in which E. coli strain CJ236 (dut⁻ ung⁻) is used to generate uridine-containing single-stranded phagemid DNA (U-ssDNA). This DNA is used as a template for second-strand synthesis using an oligonucleotide, not only as a primer of the second strand, but also to insert encoding random amino acids. Upon completion of second strand synthesis, the double stranded (dsDNA) is transformed into a wild-type strain. Any U-ssDNA is degraded by the host cell, thus leaving only the recombinant strand to generate phage particles. This method can be utilized to generate peptide fusions or mutations to the M13 coat proteins. The method of Kay et al. uses an amber stop codon at beginning of gene III. Oligonucleotides containing randomized stretches of DNA sequence are annealed to the single-stranded phage genome, such that the randomized region aligns with the stop codon. The single stranded DNA (ssDNA) is enzymatically converted to covalently-closed, circular dsDNA and subsequently electroporated into a non-suppressor strain of E. coli. The newly synthesized DNA strand (minus strand) serves as the template for generation of the plus strand in the host cell, which is utilized for transcription/translation of viral genes and is packaged into the virus particle.

### Examples 1-3

### Prophetic

### Identification of Skin Conditioner-Resistant Skin-Binding Peptides

The purpose of these prophetic Examples is to describe how to identify skin conditioner-resistant skin-binding peptides from three random phage display peptide libraries, specifically, the Ph.D.-12™ Phage Display Peptide Library, the 15-mer and the 20-mer random peptide libraries.

For the process, a unique pig skin-bottom 96-well apparatus is made by applying one layer of Parafilm® under the top 96-well block of a Minifold I Dot-Blot System (Schleicher & Schuell, Inc., Keene, N.H.), adding a layer of hairless pig skin on top of the Parafilm® cover, and then tightening the apparatus. The pig skin may be purchased from a local supermarket and stored at −80° C. Before use, the skin is placed in deionized water to thaw, and then blotted dry using a paper towel. The surface of the skin is wiped with 90% isopropanol, and then rinsed with deionized water.

A sample containing approximately 4×10¹⁰ pfu of the phage from the library of interest is used in each experiment. The sample of the phage library is first pretreated to remove hair and plastic-binding clones. To remove hair-binding clones, the sample of the phage library is incubated for 1 h at room temperature with a sample of human hair, obtained from International Hair Importers and Products (Bellerose, N.Y.). This is done using the following procedure. The hairs are first placed in 90% isopropanol for 30 min at room temperature and then washed 5 times for 10 min each with deionized water. The hairs are air-dried overnight at room temperature. The hairs are cut to a length of 1 cm and 10-20 hairs are placed into a microcentrifuge tube for incubation with the phage library. After exposure to the hair sample, the phage sample is transferred to a polystyrene, 6-well cell culture cluster (Corning Inc., Acton, Mass.; Cat. No. 3526) and incubated for 1 h at room temperature to remove plastic-binding clones.

The pretreated phage sample is added to the apparatus containing the pig skin sample and the mixture is incubated at room temperature for 1 h. The phage solution is removed and the pig skin sample is incubated in undiluted Olay Age Defying Protective Renewal Lotion (Proctor & Gamble, Cincinnati, Ohio) for 5 min at room temperature. The pig skin sample is then washed six times with TBST-0.5% buffer. After the washes, the pig skin is treated with elution buffer, consisting of 1 mg/mL BSA in 0.2 M glycine-HCl, pH 2.2, and incubated for 10 min. Then, neutralization buffer consisting of 1 M Tris-HCl, pH 9.2, is added. The phages that are eluted or still bound to the pig skin are amplified by adding fresh host cells (E. coli ER2338). The amplified and isolated phage is contacted with a fresh skin sample and the biopanning procedure is repeated two more times for each library.

After the third biopanning round, random single phage clones are selected and single plaque lysates are prepared following the manufacture's instructions (New England BioLabs) and the single stranded phage genomic DNA is purified using the QIAprep Spin M13 Kit (Qiagen; Valencia, Calif.) and sequenced at the DuPont Sequencing Facility using −96 gIII sequencing primer (5′-CCCTCATAGTTAGCGTAACG-3′), given as SEQ ID NO:2. The displayed peptide is located immediately after the signal peptide of gene III. The identified skin-binding peptide sequences are expected to be able to bind to skin from the skin conditioner matrix and to be stable therein.

### Example 4

### Prophetic

### Specificity of Skin Conditioner-Resistant Skin-Binding Peptides

The purpose of this prophetic Example is to describe how to determine the specificity of the skin conditioner-resistant skin-binding peptides that are identified using the method described in Examples 1-3 using an ELISA procedure.

The skin conditioner resistant skin-binding peptides identified using the method described in Examples 1-3 are used along with a control peptide, an unrelated hair-binding peptide, I-B5 (Huang et al. supra), given as SEQ ID NO:3. All of the peptides are synthesized with an added lysine residue, derivatized with the fluorescent tag 5-carboxyfluorescein-aminohexyl amidite (5-FAM), at the C-terminus by SynPep (Dublin, Calif.). The sequence of the labeled I-B5 hair-binding peptide is given as SEQ ID NO:4.

For the assay, a unique hair or pig skin-bottom 96-well apparatus is created by applying one layer of Parafilm® under the top 96-well block of a Minifold I Dot-Blot System (Schleicher & Schuell, Inc., Keene, N.H.), adding hair or a layer of hairless pig skin on top of the Parafilm® cover, and then tightening the apparatus. The hair or skin sample in the 96-well apparatus is first blocked with SuperBlock® Blocking Buffer (Tris-buffered; Pierce Biotechnology, Rockford, Ill.) by incubating the sample for 1 h at room temperature. Then, the hair or skin sample is washed six times with wash buffer (TBST-0.5%). The fluorescently tagged peptide, at a concentration of 20 μM in 1.0 mL of binding buffer (TBST-0.5% containing 1 mg/mL BSA), is added to each well and incubated for 30 min at 37° C. The hair or skin sample is washed six times with TBST-0.5%, and then, 1.0 mL of anti-fluorescein/Mouse IgG (Molecular Probes, Inc., Eugene, Oreg.) solution (1:1000 dilution in blocking buffer) is added per well. The samples are incubated for 1 h at room temperature and then washed six times with wash buffer. Then, 1.0 mL of Anti-Mouse IgG-HRP conjugate (Pierce Biotechnology) solution (1:1000 dilution in blocking buffer) is added to each well and the samples are incubated for 1 h at room temperature. The samples are washed six times with wash buffer, and 300 μL of TMB Substrate (Pierce Biotechnology) is added to each well. The samples are incubated for 10 min at room temperature and then a 100 μL sample from each well is taken and added to a well in a new microtiter plate. Then, 100 μL of Stop solution (2 M sulfuric acid solution) is added to each well and the absorbance of each sample is measured at a wavelength of 450 nm. This assay is done with duplicate runs, each consisting of at least three replicates.

It is expected that the skin conditioner-resistant skin-binding peptides will have a strong binding affinity to skin, as indicated by a high A₄₅₀ value, and a low binding affinity to hair, as indicated by a low A₄₅₀ value. The control hair-binding peptide I-B5 will have a low binding affinity to skin and a high binding affinity to hair.

### Example 5

### Prophetic

### Binding of Skin Conditioner-Resistant Skin-Binding Peptides to Skin from a Skin Conditioner Matrix

The purpose of this prophetic Example is to describe how to demonstrate that the skin-conditioner resistant skin-binding peptides bind to skin from a skin conditioner matrix.

The same ELISA method described in Example 4 is used. The skin-binding peptides, identified in Examples 1-3, are mixed separately with undiluted Olay Age Defying Protective Renewal Lotion using a high-shear mixer (Silverson, Model L4R7A; Silverson Machines, East Longmeadow, Mass.) for 6 min to give a final peptide concentration of 20 μM. The pig skin samples are blocked as described in Example 4 and then incubated in the peptide-conditioner mixtures for 30 min at 37° C. The pig skin samples are then washed and treated as described in Example 4 and the absorbance of each sample is measured at a wavelength of 450 nm.

The binding of the skin-binding peptides to skin from buffer is determined using the same procedure. In addition, controls are run using the same procedure, without any skin-binding peptide present, in both skin conditioner and buffer.

It is expected that the binding affinity, as indicated by the A₄₅₀ value, for the skin-binding peptides will be similar in the skin conditioner matrix and in buffer, indicating that the skin conditioner-resistant skin-binding peptides bind to strongly to skin from a skin conditioner matrix.

### Example 6

### Prophetic

### Stability of Skin Conditioner-Resistant Skin-Binding Peptides in a Skin Conditioner Matrix

The purpose of this prophetic Example is to describe how to demonstrate the stability of the skin conditioner-resistant skin-binding peptides in a skin conditioner matrix.

Separate mixtures of the skin-binding peptides, identified in Example 1-3, in skin conditioner are prepared as described in Example 5. For purposes of comparison, solutions of the skin-binding peptides in buffer are used. All the solutions are stored at room temperature and the binding activity of the peptides are determined using the ELISA procedure described in Example 5 using samples taken at different periods of time. Controls are also run with buffer and skin conditioner that did not contain the skin-binding peptide.

It is expected that there will be no significant decrease in binding affinity, as indicated by the A₄₅₀ value, for the skin-binding peptides after storage in the skin conditioner for a period of time up to 21 days.

### Examples 7-10

### Prophetic

### Identification of Skin Cleanser-Resistant Skin-Binding Peptides

The purpose of these prophetic Examples is to describe how to identify skin cleanser-resistant skin-binding peptides from three random phage display peptide libraries, specifically, the Ph.D.-12™ Phage Display Peptide Library, the 15-mer and the 20-mer random peptide libraries.

The procedure described in Examples 1-3 is used, except that the skin cleanser Johnson's Head-to-Toe Baby Wash (Johnson & Johnson, Skillman, N.J.) is used in place of the skin conditioner.

The identified skin-binding peptide sequences are expected to be able to bind to skin from the skin cleanser matrix and to be stable therein. The specificity of the skin-binding peptides are determined as described in Example 4. The ability of the skin-binding peptides to bind to skin from the skin cleanser matrix is determined using the procedure described in Example 5, and the stability of the skin-binding peptides in the skin cleanser matrix is determined as described in Example 6.

### Examples 11-13

### Identification of Body Wash-Resistant Skin-Binding Peptides

The purpose of these Examples was to identify body wash-resistant skin-binding peptides from three random phage display peptide libraries, specifically, the Ph.D.-12™ Phage Display Peptide Library, the 15-mer random peptide library, and the 14-mer disulfide constrained random peptide library.

For the process, a unique pig skin-bottom 96-well apparatus was made by applying one layer of Parafilm® under the top 96-well block of a Minifold I Dot-Blot System (Schleicher & Schuell, Inc., Keene, N.H.), adding a layer of hairless pig skin on top of the Parafilm® cover, and then tightening the apparatus. The pigskin was purchased from a local supermarket and was stored at −80° C. Before use, the skin was placed in deionized water to thaw, and then blotted dry using a paper towel. The surface of the skin was wiped with 90% isopropanol, and then rinsed with deionized water.

The skin sample in the 96-well apparatus was first blocked with SuperBlock® Blocking Buffer (Tris-buffered; Pierce Biotechnology, Rockford, Ill.) by incubating for 1 h at room temperature. Then, the skin sample was washed six times with wash buffer (TBST-0.5%).

A sample containing approximately 1×10¹¹ pfu of the phage from the library of interest was used in each experiment. The sample of the phage library was premixed with Johnson's Head-to-Toe Baby Wash (Johnson & Johnson, Skillman, N.J.) and was added to the skin-well and incubated at 37° C. for 30 min with gentle shaking. After this time, the unbounded phage particles were removed and discarded. Then, the skin sample was washed ten times with TBST buffer (0.5% Tween 20). Before eluting the bound phage from the skin, the top plate of the apparatus (the part above the skin that forms the wells) was removed and replaced with a new plate. This step removed any plastic-binding phages. The pigskin was treated with elution buffer, consisting of 1 mg/mL BSA in 0.2 M glycine-HCl, pH 2.2, and incubated for up to 20 min. Then, neutralization buffer consisting of 1 M Tris-HCl, pH 9.2, was added. The phages that were eluted or still bound to the pigskin were amplified by adding fresh host cells (E. coli ER2338). The amplified and isolated phage was contacted with a fresh pigskin sample and the biopanning procedure was repeated three more times for each library.

After the fourth biopanning round, random single phage clones were selected and single plaque lysates were prepared following the manufacture's instructions (New England Biolabs) and the single stranded phage genomic DNA was purified using the QIAprep Spin M13 Kit (Qiagen; Valencia, Calif.) and sequenced at the DuPont Sequencing Facility using −96 gIII sequencing primer (5′-CCCTCATAGTTAGCGTAACG-3′), given as SEQ ID NO:2. The displayed peptide was located immediately after the signal peptide of gene III. The identified body wash-resistant skin-binding peptide sequences are shown in Table 1.

TABLE 1

Amino Acid Sequences of Body Wash-Resistant Skin-Binding
Peptides

| | | | | | |
|---|---|---|---|---|---|
| | | | | SEQ | |
| | Phage | | | ID | Frequency |
| Example | Library | Clone ID | Amino Acid Sequence | NO: | (%) |

| | | | | | |
|---|---|---|---|---|---|
| 11 | 12-mer | Skin- | TMGFTAPRFPHY | 8 | 59 |
| | | 12mer-1 | | | |
| 11 | 12-mer | Skin- | SVSVGMKPSPRP | 9 | 12 |
| | | 12mer-2 | | | |
| 11 | 12-mer | Skin- | NLQHSVGTSPVW | 10 | 6 |
| | | 12mer-3 | | | |
| 11 | 12-mer | Skin- | NHSNWKTAADFL | 11 | 4 |
| | | 12mer-4 | | | |
| 11 | 12-mer | Skin- | NQAASITKRVPY | 12 | 4 |
| | | 12mer-5 | | | |
| 11 | 12-mer | Skin- | GSSTVGRPSLYE | 13 | 4 |
| | | 12mer-6 | | | |
| 11 | 12-mer | Skin- | SDTISRLHVSMT | 14 | 4 |
| | | 12mer-7 | | | |
| 11 | 12-mer | Skin- | SPLTVPYERKLL | 15 | 4 |
| | | 12mer-8 | | | |
| 11 | 12-mer | Skin- | SPYPSWSTPAGR | 16 | 4 |
| | | 12mer-9 | | | |
| 11 | 12-mer | Skin- | VQPITNTRYEGG | 17 | 4 |
| | | 12mer- | | | |
| | | 10 | | | |
| 11 | 12-mer | Skin- | WPMHPEKGSRWS | 18 | 4 |
| | | 12mer- | | | |
| | | 11 | | | |
| 12 | 15-mer | Skin- | QLSYHAYPQANHHAP | 19 | 20 |
| | | 15mer-1 | | | |
| 13 | 14-mer | Skin- | SGCHLVYDNGFCDH | 20 | 9 |
| | | cys-1 | | | |
| 13 | 14-mer | Skin- | ASCPSASHADPCAH | 21 | 6 |
| | | cys-2 | | | |
| 13 | 14-mer | Skin- | NLCDSARDSPRCKV | 22 | 6 |
| | | cys-3 | | | |
| 13 | 14-mer | Skin- | DACSGNGHPNNCDR | 23 | 4 |
| | | cys-4 | | | |
| 13 | 14-mer | Skin- | DHCLGRQLQPVCYP | 24 | 4 |
| | | cys-5 | | | |
| 13 | 14-mer | Skin- | DWCDTIIPGRTCHG | 25 | 4 |
| | | cys-6 | | | |

### Example 14

### Characterization of Body Wash-Resistant Skin-Binding Peptides

The purpose of this Example was to evaluate the skin binding affinity of the body wash-resistant skin binding peptides using an ELISA procedure.

Phage-peptide clones identified in Examples 11-13 were amplified by infecting fresh host cells (E. coli ER2338). The pigskin-bottom 96-well apparatus system described in Examples 11-13 was used for the ELISA procedure. For each clone to be tested, the pigskin well was incubated for 1 h at room temperature with 400 μL of blocking buffer, consisting of 2% non-fat dry milk (Schleicher & Schuell, Inc.) in TBS. The blocking buffer was removed by inverting the systems and blotting them dry with paper towels. The systems were rinsed 6 times with wash buffer consisting of TBST-0.05%. The wells were filled with 100 μL of TBST-0.5% containing 1 mg/mL of BSA and 1×10¹¹ pfu of phage. The samples were incubated at 37° C. for 15 min with slow shaking. The non-binding phage was removed by washing the wells 10 to 20 times with TBST-0.5%. Then, 100 μL of horseradish peroxidase/anti-M13 antibody conjugate (Amersham USA, Piscataway, N.J.), diluted 1:500 in the blocking buffer, was added to each well and incubated for 1 h at room temperature. The conjugate solution was removed and the wells were washed 6 times with TBST-0.05%. TMB substrate (200 μL), obtained from Pierce Biotechnology (Rockford, Ill.) was added to each well and the color was allowed to develop for between 5 to 30 min, typically for 10 min, at room temperature. Then, stop solution (200 μL of 2 M H₂SO₄) was added to each well and the solution was transferred to a 96-well plate and the absorbance at 450 nm (A₄₅₀) was measured using a microplate spectrophotometer (Molecular Devices, Sunnyvale, Calif.). The resulting absorbance values, reported as the mean of at least three replicates, and the standard error of the mean (SEM) are given in Table 2.

TABLE 2
Results of ELISA Assay

| Clone ID | SEQ ID NO: | A₄₅₀ ± SEM |
|---|---|---|
| Control, no phage | — | 0.076 ± 0.012 |
| Skin-12mer-1 | 8 | 0.506 ± 0.097 |
| Skin-12mer-2 | 9 | 0.818 ± 0.108 |
| Skin-12mer-4 | 11 | 0.874 ± 0.039 |
| Skin-12mer-5 | 12 | 0.391 ± 0.036 |
| Skin-12mer-6 | 13 | 0.677 ± 0.104 |
| Skin-12mer-7 | 14 | 1.134 ± 0.093 |
| Skin-12mer-8 | 15 | 0.433 ± 0.05 |
| Skin-12mer-9 | 16 | 1.146 ± 0.131 |
| Skin-12mer-10 | 17 | 0.418 ± 0.036 |
| Skin-12mer-11 | 18 | 0.81 ± 0.038 |
| Skin-15mer-1 | 19 | 1.264 ± 0.166 |
| Skin-cys-1 | 20 | 1.385 ± 0.046 |
| Skin-cys-2 | 21 | 1.184 ± 0.044 |
| Skin-cys-3 | 22 | 0.927 ± 0.044 |
| Skin-cys-4 | 23 | 0.852 ± 0.033 |
| Skin-cys-6 | 25 | 1.657 ± 0.047 |

As can be seen from the data in Table 2, the clones had varying affinities for skin, as measured by the A₄₅₀ values. However, all the clones had a significant affinity for skin, as indicated by A₄₅₀ values that were significantly higher than the A₄₅₀ value obtained with the control.

### Example 15

### Characterization of Body Wash-Resistant Skin-Binding Peptides After Body Wash Treatment

The purpose of this Example was to evaluate the skin binding affinity of selected body wash-resistant skin binding peptides after treatment with body wash using an ELISA procedure.

The ELISA procedure described in Example 14 was used with the following modification. After removal of the non-binding phage peptide solution from the wells, 200 μL of Johnson's Head-to-Toe Baby Wash was added to the wells and was incubated for 30 min. The washes and color development steps described in Example 14 were followed. For the buffer wash samples, the same procedure described in Example 14 was used. Two hair-binding phage peptides, IB5 and D21, given as SEQ ID NOs:3 and 26 respectively, which have a known low binding affinity for skin, were tested using the same procedure as controls. The resulting absorbance values, reported as the mean of at least three replicates, and the standard error of the mean are given in Table 3.

TABLE 3
Results of ELISA Assay after Body Wash Treatment

| | | Body Wash | Buffer Wash |
|---|---|---|---|
| Clone ID | SEQ ID NO | A₄₅₀ ± SEM | A₄₅₀ ± SEM |
| Control, no | — | 0.050 ± 0.004 | 0.093 ± 0.020 |
| phage | | | |
| IB5, hair | 3 | 0.453 ± 0.035 | 0.202 ± 0.010 |
| control | | | |
| D21, hair | 26 | 0.549 ± 0.053 | 0.297 ± 0.004 |
| control | | | |
| Skin-12mer-9 | 16 | 2.265 ± 0.132 | 1.298 ± 0.11 |
| Skin-15mer-1 | 19 | 1.447 ± 0.178 | 1.031 ± 0.045 |
| Skin-cys-1 | 20 | 1.444 ± 0.293 | 1.182 ± 0.070 |

The results demonstrate that the body wash-resistant skin-binding phage peptides have a high binding affinity for skin and maintain significant binding affinity for skin after treatment with body wash. The hair-binding controls had a significantly lower binding affinity for skin than the skin-binding phage peptides after the buffer wash and after the body wash treatment, as expected.

### Example 16

### Prophetic

### Specificity of Body Wash-Resistant Skin-Binding Peptides

The purpose of this prophetic Example is to describe how to determine the specificity of the body wash-resistant skin-binding peptides identified in Examples 11-13 using an ELISA procedure.

The body wash-resistant skin-binding peptides identified in Examples 11-13 are used along with a control peptide, an unrelated hair-binding peptide, I-B5 (Huang et al. supra), given as SEQ ID NO:3. All of the peptides are synthesized with an added lysine residue, derivatized with the fluorescent tag 5-carboxyfluorescein-aminohexyl amidite (5-FAM), at the C-terminus by SynPep (Dublin, Calif.).

For the assay, a unique hair or pig skin-bottom 96-well apparatus is created by applying one layer of Parafilm® under the top 96-well block of a Minifold I Dot-Blot System (Schleicher & Schuell, Inc., Keene, N.H.), adding hair or a layer of hairless pig skin on top of the Parafilm® cover, and then tightening the apparatus. The hair or skin sample in the 96-well apparatus is first blocked with SuperBlock® Blocking Buffer (Tris-buffered; Pierce Biotechnology, Rockford, Ill.) by incubating the sample for 1 h at room temperature. Then, the hair or skin sample is washed six times with wash buffer (TBST-0.5%). The fluorescently tagged peptide, at a concentration of 20 μM in 1.0 mL of binding buffer (TBST-0.5% containing 1 mg/mL BSA), is added to each well and incubated for 30 min at 37° C. The hair or skin sample is washed six times with TBST-0.5%, and then, 1.0 mL of anti-fluorescein/Mouse IgG (Molecular Probes, Inc., Eugene, Oreg.) solution (1:1000 dilution in blocking buffer) is added per well. The samples are incubated for 1 h at room temperature and then washed six times with wash buffer. Then, 1.0 mL of Anti-Mouse IgG-HRP conjugate (Pierce Biotechnology) solution (1:1000 dilution in blocking buffer) is added to each well and the samples are incubated for 1 h at room temperature. The samples are washed six times with wash buffer, and 300 μL of TMB Substrate (Pierce Biotechnology) is added to each well. The samples are incubated for 10 min at room temperature and then a 100 μL sample from each well is taken and added to a well in a new microtiter plate. Then, 100 μL of Stop solution (2 M sulfuric acid solution) is added to each well and the absorbance of each sample is measured at a wavelength of 450 nm. This assay is done with duplicate runs, each consisting of at least three replicates.

It is expected that the body wash-resistant skin-binding peptides will have a strong binding affinity to skin, as indicated by a high A₄₅₀ value, and a low binding affinity to hair, as indicated by a low A₄₅₀ value. The control hair-binding peptide I-B5 will have a low binding affinity to skin and a high binding affinity to hair.

### Example 17

### Prophetic

### Skin-Binding Peptide-Based Skin Conditioner

The purpose of this prophetic Example is to describe how to prepare a peptide-based skin conditioner by coupling a body wash-resistant skin-binding peptide with 8-arm polyethylene glycol (8-arm PEG) using 3-maleimidopropionic acid as a linker.

Functionalization of 8-Arm PEG:

A solution of 8-arm PEG (Mw 10 kDa; available from Nektar Transforming Therapeutics, Huntsville, Ala.) is prepared by dissolving 0.97 g (0.78 mmol) in 20 mL of tetrahydrofuran (THF). The solution is well stirred under nitrogen and 2 mL of 3-maleimidopropionic acid solution (7.5 mmol; Aldrich) is added. Then, 2 mL of N,N′-dicyclohexyl-carbodiimide (DCC) solution (1.55 g in 2 mL of DMF) is added, followed by the drop-wise addition of 250 μL of dimethylaminopyridine (DMAP). The mixture is stirred overnight at 50° C. The next day, the mixture is cooled to room temperature and filtered using a medium frit filter funnel (Chemglass Inc, Vineland, N.J.). The filtrate is precipitated with a large quantity of ether/DMF (v/v of 30:1). The precipitate is collected and dissolved in 70 mL of water, forming a uniform aqueous solution. The aqueous solution is extracted with ether 4 times. Finally, the aqueous portion is lyophilized to yield a dry powder.

Coupling of the Functionalized 8-Arm PEG-Linker with a Skin-Binding Peptide:

The functionalized 8 arm-PEG-linker, prepared as described above, is suspended in TBS buffer and an equal molar ratio of a body wash-resistant skin-binding peptide Skin-cys-1 (SEQ ID NO:20) having a cysteine residue added to the C-terminus of the peptide sequence (given as SEQ ID NO:27, obtained from SynPep), is added to the solution. The mixture is stirred at room temperature for 6 h. The final product is purified by extraction with water/ether and is analyzed by NMR.

### Example 18

### Prophetic

### Preparation of a Peptide-Based Skin Colorant

The purpose of this prophetic Example is to describe how to prepare a peptide-based skin colorant by covalently attaching the body wash-resistant skin-binding peptide Skin-cys-1 (SEQ ID NO:20) to Disperse Orange 3 dye. The dye is first functionalized with isocyanate and then is reacted with the Skin-cys-1 peptide.

Functionalization of Disperse Orange 3:

In a dry box, 14.25 g of Disperse Orange 3 (Aldrich) is suspended in 400 mL of dry THF in an addition funnel. A 2-liter, four-neck reaction flask (Corning Inc., Corning, N.Y.; part no. 1533-12), containing a magnetic stir bar, is charged with 200 mL of dry toluene. The flask is fitted with a cold finger condenser (Corning Inc., part no. 1209-04) and with a second cold finger condenser with an addition funnel, and is placed on an oil bath in a hood.

Phosgene (25.4 mL) is condensed into the reaction flask at room temperature. After phosgene addition is complete, the temperature of the oil bath is raised to 80° C. and the Disperse Orange 3 suspension is added to the reaction flask dropwise in 100 mL increments over 2 h, while monitoring the reaction temperature and gas discharge from the scrubber. The temperature is maintained at or below 64° C. throughout the addition. After addition is complete, the reactants are heated at 64° C. for 1 h and then allowed to cool to room temperature with stirring overnight.

The reaction solvents are vacuum-distilled to dryness, while maintaining the contents at or below 40° C., and vacuum is maintained for an additional hour. The reaction flask is transferred to a dry box; the product is collected and dried overnight. The desired product is confirmed by proton NMR.

Coupling of Isocyanate Functionalized Dye with Skin-cys-1 Skin-Binding Peptide:

Isocyanate functionalized Disperse Orange 3 [(2-(4-isocyantophenyl)-1-(4-nitrophenyl)diazene](16 mg), prepared as described above, is dissolved in 5 mL of DMF and added to a solution containing 75 mg of non-protected Skin-cys-1 peptide (SEQ ID NO:20), from SynPep, dissolved in 10 mL of DMF. Triethylamine (30 mg) is added to catalyze the reaction. The solution is stirred at room temperature for 24 h. The solvent is evaporated yielding a dark red-brown powder product. The product is analyzed by MALDI mass spectrometry to confirm adduct formation.

What is claimed is:

1. A method for identifying a skin care composition-resistant skin-binding peptide comprising:
a) providing a combinatorial library of DNA associated peptides;
b) contacting the library of (a) with a skin sample wherein the skin complexes with the DNA associated peptides to form a reaction solution comprising DNA associated peptide-skin complexes;
c) isolating the DNA associated peptide-skin complexes of (b) from the reaction solution;
d) contacting the isolated DNA associated peptide-skin complexes of (c) with a skin care composition matrix to form a peptide-skin complex-composition mixture wherein the concentration of the skin care composition matrix is at least about 10% of full strength concentration;
e) isolating the DNA associated peptide-skin complexes of (d) from the peptide-skin complex-composition mixture;
f) amplifying the DNA encoding the peptide portion of the DNA associated peptide-skin complexes of (e); and
g) sequencing the amplified DNA of (f) encoding a skin care composition-resistant skin-binding peptide wherein the skin care composition-resistant skin-binding peptide is identified.

2. A method according to claim 1 wherein after step (e):
i) peptides of the DNA associated peptide-skin complexes are contacted with an eluting agent whereby a portion of DNA associated peptides are eluted from the skin and a portion of DNA associated peptides remain complexed; and
ii) the eluted or complexed DNA associated peptides of (ii) are subjected to steps (f) and (g).

3. A method according to either of claims 1 or 2 wherein the DNA encoding the peptides is amplified by a process selected from the group consisting of:
a) polymerase chain reaction; and
b) infecting a host cell with a phage comprising DNA encoding the peptide and growing said host cell in an appropriate growth medium.

4. A method according to either of claims 1 or 2 wherein the peptides encoded by the amplified DNA of step (f) are contacted with a fresh skin sample and steps (b) through (f) are repeated one or more times.

5. A method according to claim 1 wherein step (d) is repeated one or more times.

6. A method according to claim 1 wherein the combinatorial library of DNA associated peptides is provided in a skin care composition matrix and is contacted with a skin sample to form a reaction solution comprising DNA associated peptide-skin complexes, wherein the concentration of the skin care composition matrix is at least about 10% of full strength concentration.

7. A method according to claim 1 wherein the combinatorial library of DNA associated peptides is provided in a skin care composition matrix and is contacted with a skin sample to form a reaction solution comprising DNA associated peptide-skin complexes, wherein the concentration of skin care composition matrix is at least about 10% of full strength concentration and wherein steps (d) and (e) are optionally deleted.

8. A method according to claim 1 wherein the combinatorial library of DNA associated peptides is generated by a method selected from the group consisting of phage display, bacterial display, and yeast display.

9. A method according to claim 1 wherein the combinatorial library of DNA associated peptides is optionally contacted with a non-target either prior to or simultaneously with contacting the skin sample to remove peptides that bind to the non-target

10. A method according to claim 1 wherein the concentration of the skin care composition matrix is at least about 20% of full strength concentration.

11. A method according to claim 1 wherein the concentration of the skin care composition matrix is at least about 50% of full strength concentration.

12. A method according to claim 1 wherein the concentration of the skin care composition matrix is at least about 75% of full strength concentration.

13. A method according to claim 1 wherein the skin care composition matrix is undiluted.

14. A method according to claim 2 wherein the eluting agent is selected from the group consisting of acid, base, salt solution, water, ethylene glycol, dioxane, thiocyanate, guanidine, and urea.

15. A method according to claim 1 wherein the skin care composition matrix is a skin conditioning product.

16. A method according to claim 1 wherein the skin care composition matrix is a skin cleansing product.

17. A skin care composition-resistant skin-binding peptide identified by a process comprising the steps of:
a) providing a combinatorial library of DNA associated peptides;
b) contacting the library of (a) with a skin sample wherein the skin complexes with the DNA associated peptides to form a reaction solution comprising DNA associated peptide-skin complexes;
c) isolating the DNA associated peptide-skin complexes of (b) from the reaction solution;
d) contacting the isolated DNA associated peptide-skin complexes of (c) with a skin care composition matrix to form a peptide-skin complex-composition mixture wherein the concentration of the skin care composition matrix is at least about 10% of full strength concentration;
e) isolating the DNA associated peptide-skin complexes of (d) from the peptide-skin complex-composition mixture;
f) amplifying the DNA encoding the peptide portion of the DNA associated peptide-skin complexes of (e); and
g) sequencing the amplified DNA of (f) encoding a skin care composition resistant skin-binding peptide wherein the skin care composition-resistant skin-binding peptide is identified.

18. A skin care composition-resistant hair-binding peptide selected from the group consisting of: SEQ ID NO:8, 9, 10, 11, 12, 13, 14, 15, 16, 17, 18, 19, 20, 21, 22, 23, 24, 25, and 27.

19. A diblock, peptide-based skin benefit agent having the general structure (SCPₘ)ₙ−BA, wherein;
a) SCP is a skin care composition-resistant skin-binding peptide;
b) BA is a benefit agent;
c) m ranges from 1 to about 100; and
d) n ranges from 1 to about 50,000.

20. A triblock, peptide-based skin benefit agent having the general structure [(SCPₓ−S)ₘ]ₙ−BA, wherein;
a) SCP is a skin care composition-resistant skin-binding peptide;
b) BA is a benefit agent;
c) S is a spacer;
d) x ranges from 1 to about 10;
e) m ranges from 1 to about 100; and
f) n ranges from 1 to about 50,000.

21. A diblock, peptide-based benefit agent according to claim 19 wherein the benefit agent is a skin conditioning agent.

22. A triblock, peptide-based benefit agent according to claim 20 wherein the benefit agent is a skin conditioning agent.

23. A diblock, peptide-based benefit agent according to claim 19 wherein the benefit agent is a coloring agent.

24. A triblock, peptide-based benefit agent according to claim 20 wherein the benefit agent is a coloring agent.

25. A peptide-based benefit agent according to any of claims 19-24 wherein the skin care composition-resistant skin-binding peptide is isolated by a process comprising the steps of:
a) providing a combinatorial library of DNA associated peptides;
b) contacting the library of (a) with a skin sample wherein the skin complexes with the DNA associated peptide to form a reaction solution comprising DNA associated peptide-skin complexes;
c) isolating the DNA associated peptide-skin complexes of (b) from the reaction solution;
d) contacting the isolated DNA associated peptide-skin complexes of (c) with a skin care composition matrix to form a peptide-skin complex-composition mixture wherein the concentration of the skin care composition matrix is at least about 10% of full strength concentration;
e) isolating the DNA associated peptide-skin complexes of (d) from the peptide-skin complex-composition mixture;
f) amplifying the DNA encoding the peptide portion of the DNA associated peptide-skin complexes of (e); and
g) sequencing the amplified DNA of (f) encoding a skin care composition-resistant skin-binding peptide wherein the skin care composition-resistant skin-binding peptide is identified.

26. A peptide-based benefit agent according to any of claims 19-24 wherein the skin care composition-resistant skin-binding peptide is from about 7 amino acids to about 25 amino acids in length.

27. A peptide-based benefit agent according to any of claims 19-24 wherein the skin care composition-resistant skin-binding peptide is from about 12 amino acids to about 20 amino acids in length.

28. A peptide-based benefit agent according to any of claims 19-24 wherein the skin care composition-resistant skin-binding peptide further comprises at least one cysteine residue on at least one end of the peptide selected from the group consisting of:
a) the N-terminal end; and
b) the C-terminal end.

29. A peptide-based benefit agent according to any of claims 19-24 wherein the skin care composition-resistant skin-binding peptide further comprises at least one lysine residue on at least one end of the peptide selected from the group consisting of:
a) the N-terminal end; and
b) the C-terminal end.

30. A peptide-based benefit agent according to any of claims 19-24 wherein the skin care composition-resistant skin-binding peptide has an amino acid sequence selected from the group consisting of SEQ ID NO:8, 9, 10, 11, 12, 13, 14, 15, 16, 17, 18, 19, 20, 21, 22, 23, 24, 25, and 27.

31. A peptide-based benefit agent according to claim 21 or 22 wherein the skin conditioning agent is selected from the group consisting of polysalicylates, propylene glycol, glycerin, glycolic acid, lactic acid, malic acid, citric acid, tartaric acid, glucaric acid, galactaric acid, 3-hydroxyvaleric acid, salicylic acid, and 1,3 propanediol.

32. A peptide-based benefit agent according to claim 23 or 24 wherein the coloring agent is selected from the group consisting of D&C Red No. 21, D&C Red No. 27, D&C Red Orange No. 5, D&C Red No. 21, D&C Orange No. 10, titanium dioxide, zinc oxide, D&C Red No. 36, D&C Orange No. 17, the calcium lakes of D&C Red Nos. 7, 11, 31, 34, the barium lake of D&C Red No. 12, the strontium lake D&C Red No. 13, the aluminum lake of FD&C Yellow No. 5, the aluminum lake of FD&C Yellow No. 6, the aluminum lake of D&C Red No. 27, the aluminum lake of D&C Red No. 21, the aluminum lake of FD&C Blue No. 1, iron oxides, manganese violet, chromium oxide, ultramarine blue, carbon black, dihydroxyacetone, and colored microspheres.

33. A peptide-based benefit agent according to claim 32 wherein the colored microspheres are comprised of materials selected from the group consisting of polystyrene, polymethylmethacrylate, polyvinyltoluene, styrene/butadiene copolymer, and latex; and wherein the microspheres have a diameter of about 10 nanometers to about 2 microns.

34. A peptide-based benefit agent according to any of claims 20, 22, or 24 wherein the spacer is selected from the group consisting of ethanol amine, ethylene glycol, polyethylene with a chain length of 6 carbon atoms, polyethylene glycol with 3 to 6 repeating units, phenoxyethanol, propanolamide, butylene glycol, butyleneglycolamide, propyl phenyl, ethyl alkyl chain, propyl alkyl chain, hexyl alkyl chain, steryl alkyl chains, cetyl alkyl chains, and palmitoyl alkyl chains.

35. A peptide-based benefit agent according to any of claims 20, 22, or 24 wherein the spacer is a peptide comprising amino acids selected from the group consisting of proline, lysine, glycine, alanine, serine, and mixtures thereof.

36. A peptide-based benefit agent according to any of claims 20, 22, or 24 wherein the spacer is a peptide comprising an amino acid sequence selected from the group consisting of SEQ ID NO:1, SEQ ID NO:5, SEQ ID NO:6, and SEQ ID NO:7.

37. A skin care product composition comprising an effective amount of the peptide-based benefit agent of claim 19 or 20.

38. A skin conditioning product composition comprising an effective amount of the peptide-based benefit agent of claim 21 or 22.

39. A skin coloring product composition comprising an effective amount of the peptide-based benefit agent of claim 23 or 24.

40. A skin coloring product composition comprising an effective amount of the peptide-based benefit agent of claim 21 or 22.

41. A skin cleansing product composition comprising an effective amount of the peptide-based benefit agent of claim 21 or 22.

42. A method for forming a protective layer of a peptide-based conditioner on skin comprising applying the composition of claim 38 to the skin and allowing the formation of said protective layer.

43. A method for coloring skin comprising applying the composition of claim 39 to the skin for a period of time sufficient to cause coloration of the skin.

44. A method for coloring skin comprising the steps of:
a) providing a skin coloring composition comprising a skin colorant selected from the group consisting of:
i) (SCPₘ)ₙ−C; and
ii) [(SCPₓ−S)ₘ]ₙ−C wherein:
1) SCP is a skin care composition-resistant skin-binding peptide;
2) C is a coloring agent;
3) n ranges from 1 to about 50,000;
4) S is a spacer;
5) m ranges from 1 to about 100; and
6) x ranges from 1 to about 10;
and wherein the skin care composition-resistant skin-binding peptide is selected by a method comprising the steps of:
A) providing a combinatorial library of DNA associated peptides;
B) contacting the library of (A) with a skin sample wherein the skin complexes with the DNA associated peptide to form a reaction solution comprising DNA associated peptide-skin complexes;
C) isolating the DNA associated peptide-skin complexes of (B) from the reaction solution;
D) contacting the isolated DNA associated peptide-skin complexes of (C) with a skin care composition matrix to form a peptide-skin complex-composition mixture wherein the concentration of the skin care composition matrix is at least about 10% of full strength concentration;
E) isolating the DNA associated peptide-skin complexes of (D) from the peptide-skin complex-composition mixture;
F) amplifying the DNA encoding the peptide portion of the DNA associated peptide-skin complexes of (E); and
G) sequencing the amplified DNA of (F) encoding a skin care composition resistant skin-binding peptide wherein the skin care composition resistant skin-binding peptide is identified; and
b) applying the skin coloring composition of (a) to skin for a time sufficient for the skin colorant to bind to skin.

45. A method for forming a protective layer of a peptide-based conditioner on skin comprising the steps of:
a) providing a skin care composition comprising a skin conditioner selected from the group consisting of:
i) (SCPₘ)ₙ−SCA; and
ii) [(SCPₓ−S)ₘ]ₙ−SCA wherein:
1) SCP is a skin care composition-resistant skin-binding peptide;
2) SCA is a skin conditioning agent;
3) n ranges from 1 to about 50,000;
4) S is a spacer;
5) m ranges from 1 to about 100; and
6) x ranges from 1 to about 10;
and wherein the skin care composition-resistant skin-binding peptide is selected by a method comprising the steps of:
A) providing a combinatorial library of DNA associated peptides;
B) contacting the library of (A) with a skin sample wherein the skin complexes with the DNA associated peptides to form a reaction solution comprising DNA associated peptide-skin complexes;
C) isolating the DNA associated peptide-skin complexes of (B) from the reaction solution;
D) contacting the isolated DNA associated peptide-skin complexes of (C) with a skin care composition matrix to form a peptide-skin complex-composition mixture wherein the concentration of the skin care composition matrix is at least about 10% of full strength concentration;
E) isolating the DNA associated peptide-skin complexes of (D) from the peptide-skin complex-composition mixture;
F) amplifying the DNA encoding the peptide portion of the DNA associated peptide-skin complexes of (E); and
G) sequencing the amplified DNA of (F) encoding a skin care composition-resistant skin-binding peptide wherein the skin care composition-resistant skin-binding peptide is identified; and
b) applying the skin care composition of (a) to skin and allowing the formation of said protective layer.


SEQUENCE LISTING (27 sequences)

SEQ ID NO: 1 - protein, 8 aa, Artificial Sequence
  Caspase 3 cleavage site
LESGDEVD

SEQ ID NO: 2 - DNA, 20 bp, Artificial Sequence
  Primer
ccctcatagttagcgtaacg

SEQ ID NO: 3 - protein, 12 aa, Artificial Sequence
  Hair-binding peptide
TPPELLHGDPRS

SEQ ID NO: 4 - protein, 13 aa, Artificial Sequence
  Fluorescently-labeled hair-binding peptide
TPPELLHGDPRSK

SEQ ID NO: 5 - protein, 37 aa, Artificial Sequence
  Peptide spacer
TSTSKASTTTTSSKTTTTSSKTTTTTSKTSTTSSSST

SEQ ID NO: 6 - protein, 22 aa, Artificial Sequence
  Peptide spacer
GQGGYGGLGSQGAGRGGLGGQG

SEQ ID NO: 7 - protein, 10 aa, Artificial Sequence
  Peptide spacer
GPGGYGPGQQ

SEQ ID NO: 8 - protein, 12 aa, Artificial Sequence
  Body wash-resistant skin-binding peptide
TMGFTAPRFPHY

SEQ ID NO: 9 - protein, 12 aa, Artificial Sequence
  Body wash-resistant skin-binding peptide
SVSVGMKPSPRP

SEQ ID NO: 10 - protein, 12 aa, Artificial Sequence
  Body wash-resistant skin-binding peptide
NLQHSVGTSPVW

SEQ ID NO: 11 - protein, 12 aa, Artificial Sequence
  Body wash-resistant skin-binding peptide
NHSNWKTAADFL

SEQ ID NO: 12 - protein, 12 aa, Artificial Sequence
  Body wash-resistant skin-binding peptide
NQAASITKRVPY

SEQ ID NO: 13 - protein, 12 aa, Artificial Sequence
  Body wash-resistant skin-binding peptide
GSSTVGRPSLYE

SEQ ID NO: 14 - protein, 12 aa, Artificial Sequence
  Body wash-resistant skin-binding peptide
SDTISRLHVSMT

SEQ ID NO: 15 - protein, 12 aa, Artificial Sequence
  Body wash-resistant skin-binding peptide
SPLTVPYERKLL

SEQ ID NO: 16 - protein, 12 aa, Artificial Sequence
  Body wash-resistant skin-binding peptide
SPYPSWSTPAGR

SEQ ID NO: 17 - protein, 12 aa, Artificial Sequence
  Body wash-resistant skin-binding peptide
VQPITNTRYEGG

SEQ ID NO: 18 - protein, 12 aa, Artificial Sequence
  Body wash-resistant skin-binding peptide
WPMHPEKGSRWS

SEQ ID NO: 19 - protein, 15 aa, Artificial Sequence
  Body wash-resistant skin-binding peptide
QLSYHAYPQANHHAP

SEQ ID NO: 20 - protein, 14 aa, Artificial Sequence
  Body wash-resistant skin-binding peptide
SGCHLVYDNGFCDH

SEQ ID NO: 21 - protein, 14 aa, Artificial Sequence
  Body wash-resistant skin-binding peptide
ASCPSASHADPCAH

SEQ ID NO: 22 - protein, 14 aa, Artificial Sequence
  Body wash-resistant skin-binding peptide
NLCDSARDSPRCKV

SEQ ID NO: 23 - protein, 14 aa, Artificial Sequence
  Body wash-resistant skin-binding peptide
DACSGNGHPNNCDR

SEQ ID NO: 24 - protein, 14 aa, Artificial Sequence
  Body wash-resistant skin-binding peptide
DHCLGRQLQPVCYP

SEQ ID NO: 25 - protein, 14 aa, Artificial Sequence
  Body wash-resistant skin-binding peptide
DWCDTIIPGRTCHG

SEQ ID NO: 26 - protein, 12 aa, Artificial Sequence
  Hair-binding sequence
RTNAADHPAAVT

SEQ ID NO: 27 - protein, 15 aa, Artificial Sequence
  Body wash-resistant skin-binding peptide with a cysteine residue at C-terminus
SGCHLVYDNGFCDHC